(19) United States
(12) Patent Application Publication
(10) Pub. No.: US 2024/0311280 A1
(43) Pub. Date: Sep. 19, 2024

(54) Productivity Test Automation Tools And Device

(71) Applicant: Tuyen Matthew Duong, San Jose, CA (US)

(72) Inventor: Tuyen Matthew Duong, San Jose, CA (US)

(21) Appl. No.: 18/120,789

(22) Filed: Mar. 13, 2023

(51) Int. Cl. G06F 11/36

(52) U.S. Cl. CPC G06F 11/3688; G06F 11/3684; G06F 11/3692

(57) ABSTRACT

A method and system for the automated productivity testing of software is provided that comprises describing a software test procedure in plain English and transferring it to a productivity test automation system application; building a test script from the test procedure in the productivity test automation system application; executing the test script to obtain a test result; reviewing the test result; optionally adopting a change to the test script after reviewing the test result, updating the test script in the productivity test automation system application, and repeating the building, executing and reviewing of the test script; deciding to accept a final test script; deploying the final test script in production testing; and integrating with a collaboration tool, a continuous integration and continuous delivery tool, a bug tracking system, and a report tool.

### FIELD OF THE INVENTION

The invention relates to automated software testing.

### BACKGROUND OF THE INVENTION

In the past, a software tester would prepare a detailed test procedure for software testing for a developer to apply that contained all of the requirements and expectations known to the tester. The developer would then attempt to apply the procedure and was required to read and understand the procedure completely before coding. The developer would create a test script and a draft test execution to produce a test result to review. The developer would then be required to wait for the tester to review the test result and to provide feedback for modification or improvement. After this process of back and forth communication concluded, and a final test script was approved, a developer must then train the tester to use the test script for his or her test automation. During the conversations between the tester and the developer, a collaboration tool, a continuous integration and continuous delivery tool, a bug tracking tool (e.g., device, multicomponent system), and a report tool are all used separately. With this separate use, artificial intelligent applications are thus less likely to integrate the test script development, the continuous integration and continuous delivery tool, the bug tracking tool, and the report tool to improve test quality and productivity.

In software testing, effective use of operational test automation tools and devices could theoretically make available the integrated use of specialized tools to control the execution of tests instead of performing manual testing. However, certain benefits from using test automation have not been achieved due to significant problems when implementing and working with the available test automation. The most common problems found in test automation are the high cost of implementation, the lack of skilled automation resources, the low-quality results, and the high cost of maintenance. Thus, better alternatives for agile quality assurance processes and test automation tools (e.g., devices and systems) are needed.

### SUMMARY OF THE INVENTION

The present invention provides solutions to the significant problems of current test automation devices (e.g., services, tools, features, systems, subroutines, one or more components). These solutions are in the forms of methods and apparatus for productivity test automation devices. Certain embodiments of this invention execute such solutions by providing, among other things, productivity test automation devices that allow users to create a test script by describing the problem in plain English language. In addition, certain embodiments of this invention comprise three main services (e.g., devices, tools, features, systems, subroutines, components): (1) connector services, (2) Describe-Get-System (“DGS” or “describe-get-tool”) services, and (3) third-party integration services. Connector services interact with devices that are being tested and/or test equipment for data processing. The DGS services interpret the requirements to generate a test script. The integration services help to improve quality and maximize productivity of test development and execution by applying the applicable third-party integration tools such as collaboration, continuous integration and continuous delivery (CI/CD), bug tracking tools (e.g., devices, services, features, systems, subsystems components), a report tool, and/or artificial intelligence.

The Describe-Get-System service integrates with DLApp, RegexApp, and TemplateApp. DLApp provides a verification service. RegexApp provides a mechanism to quickly parse data without technical knowledge of regular expression. TemplateApp is a generator to generate a template that is used to parse test data.

Describe-Get-System has four services (e.g., tools, features, systems, subroutines, components): Interpreter, Generator, Contractor, and Report. The Interpreter service interprets user test requirements to provide the workflow for the Generator. The Generator service processes workflow to produce test scripts per test frameworks such as Unittest, PyTest, or Robotframework. The Contractor service lets users choose other representatives to work or to use his or her work. The Report service provides the analysis report regarding test execution. Embodiments of these may also comprise combining one or more of these services together.

In the past, the test script development resources required a tester and a technical developer to develop a test script. In contrast, certain embodiments of this invention only require a tester with basic knowledge of the English language to build a test script. In the past, the test script development processes were “prepare, discuss, develop, execute, review, suggest, rework, approve, deploy”. In contrast, certain embodiments of this invention implement processes of productivity test automation systems that are “describe, build, execute, review, adopt, update, decide (or choose), deploy”. In addition, in the past, the test script development skill was a coding development while in certain embodiments of this invention, the productivity test automation device is a codeless development.

In certain of the preferred embodiments of this invention, a productivity test tool for use by a tester of this invention is provided. The “tool” may be in the form of a device, a service, a feature of another device or method, a system, a subroutine, or a component, and other forms known to a person of skill in the art. The productivity test tool comprises a number of components, features and/or capabilities. These comprise a memory device (e.g., a device or component that can store information, such as a hard drive, or other computer memory device) and a processing device. The processing device may comprise a computer processor. The processing device is coupled to the memory device so that it can store and retrieve information from the memory device. The processing device has multiple capabilities. These multiple capabilities comprise the capability to: (i) receive a test procedure in plain English from the tester; (ii) build a proposed test script; (iii) execute the proposed test script to obtain a test result; (iv) review the test result; (v) adopt a change to the test script after the review of the test result, (vi) update the proposed test script, and repeat (ii) through (iv); (vii) decide to accept a final test script; and (viii) deploy the final test script to production testing.

The productivity test tool of these preferred embodiments further comprises (c) an integrated collaboration tool coupled with the processing device; (d) a continuous integration and continuous delivery tool coupled with the processing device; (e) a bug tracking tool coupled with the processing device; and (f) a report tool coupled with the processing device. Other tools may be included in the productivity test tool that are known to a person of skill in the art. In the most preferred embodiments of the productivity test tool, the productivity test tool operates without the tester directly writing software code.

In certain of the preferred embodiments of this invention, a method of testing software by a tester is provided. The method comprises (a) describing a software test procedure in plain English and transferring the test procedure description to a productivity test tool; (b) building a test script from the test procedure description in the productivity test tool; (c) executing the test script to obtain a test result; (d) reviewing the test result; (e) adopting a change to the test script after reviewing the test result; (f) updating the test script in the productivity test tool, and repeating (c) and (d); (g) deciding to accept a final test script or repeating (e) and (f); (h) deploying the final test script in production testing; and (i) integrating with a collaboration tool, a continuous integration and continuous delivery tool, a bug tracking tool, and a report tool. In the most preferred embodiments of the method, the tester performs the testing without the tester directly writing software code.

In certain of the preferred embodiments of this invention, a describe-get-tool for use by a tester with a productivity test tool in provided. To use this tool, the tester provides test requirement inputs. The describe-get-tool comprises (a) an interpreter tool that interprets the test requirement inputs to provide a workflow; (b) a generator tool that processes the workflow to produce test scripts for test execution; (c) a contractor tool that lets the tester choose at least one other user to use the describe-get-tool; and (d) a report tool that provides an analysis report regarding test execution. In the most preferred embodiments of the describe-get-tool, the describe-get-tool applies What You Describe Is What You Get.

In certain preferred embodiments of this invention, a productivity test tool for testing a device corresponding to testing requirements in provided. The productivity test tool comprises (a) a connector tool, the connector tool interacting with the device that is being tested; (b) a describe-get-tool, the describe-get-tool interpreting the testing requirements to generate a test script; and (c) an integration tool, the integration tool improving the quality and productivity of the testing by applying a collaboration tool, a continuous integration and continuous deliver tool, a bug tracking tool, and a report tool. In the most preferred embodiments of this productivity test tool, the device that is being tested is test equipment for use in data processing.

Advantages of certain embodiments of this invention are described and apparent throughout this specification. Some of the advantages of certain embodiments of this invention include that the DGS service applies the “What You Describe Is What You Get” principle to solve coding implementation. Another advantage of certain embodiments of this invention is that the embodiments of the Productivity Test Automation System that are provided is a codeless development. Another advantage of certain embodiments of this invention is that they provide the best (or at the least a better) practice to implement, execute, and maintain test automation.

Another advantage of certain embodiments of this invention is that they help a manual tester to quickly engage in the test automation development process within a short period (e.g., one week) of training. Another advantage of certain embodiments of this invention are that they minimize the implementation and maintenance costs because most solutions are described in plain English. Another advantage of certain embodiments of this invention is that they provide the metric or strategy to maximize the test automation return of investment. Further advantages will be apparent to a person of skill in the art applying the embodiments of the invention.

Moreover, additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a block diagram of exemplary architecture for embodiments of productivity test automation tools and devices of this invention.

FIG. 2 is a flowchart of a common test script development process used in the past.

FIG. 3 is a flowchart of certain productivity test script development process embodiments of this invention.

FIG. 4 is a flowchart of certain embodiments of this invention showing the preparation of a TextFSM template for verification.

FIG. 5 is a flowchart of certain embodiments of this invention showing an example of text parsing workflow.

FIG. 6 is a flowchart of certain embodiments of this invention showing an example of a productivity test script development timeline.

FIG. 7 is a description of a complex test scenario.

FIG. 8 is a possible solution to the complex test scenario of FIG. 7.

FIG. 9 is an exemplary result from the Robotframework test of this invention, illustrating an embodiment of a Robotframework log.

FIG. 10 is an exemplary result from the Robotframework test of this invention, illustrating an embodiment of a Robotframework log, among other things.

FIG. 11 is an exemplary result from the Robotframework test of this invention, illustrating an embodiment of a Test Execution Log.

FIG. 12 is an exemplary result from the Robotframework test of this invention, illustrating an embodiment of a Test Execution Log.

FIG. 13 is an exemplary result from the Robotframework test of this invention, illustrating an embodiment of a Robotframework Report.

FIG. 14 is an exemplary result from the Robotframework test of this invention, illustrating another embodiment of a Robotframework Report.

FIG. 15 is an exemplary result from the Robotframework test of this invention, illustrating another embodiment of a Robotframework log, among other things.

FIG. 16 is an exemplary result from the Robotframework test of this invention, illustrating another embodiment of a Test Execution Log.

FIG. 17 is an exemplary result from the Robotframework test of this invention, illustrating another embodiment of a Robotframework log, among other things.

FIG. 18 is an exemplary result from the Robotframework test of this invention, illustrating another embodiment of a Test Execution Log.

FIG. 19 is an exemplary result from the Robotframework test of this invention, illustrating another embodiment of a Test Execution Log.

### DETAILED DESCRIPTION OF THE INVENTION

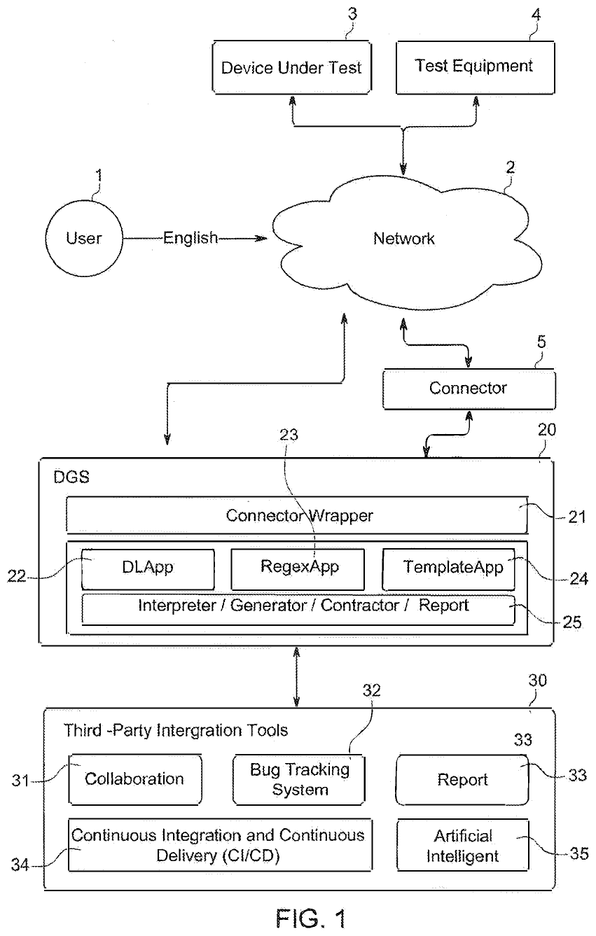

The preferred embodiments of this invention provide methods and apparatus comprising productivity test automation devices (e.g., tools, service, feature, systems, subroutine, components, which terms are used interchangeability herein and are not meant to be limiting to specific compositions or methods) that have several advantages and efficiencies. An example of a block diagram relating to certain embodiments of this invention and components that may be used is shown in FIG. 1. FIG. 3 also shows certain embodiments of this invention used in an exemplary productivity test script development system process. FIG. 3 shows that in certain embodiments of this invention, the test procedure is described in plain English 20. Thus, the system shown will solve the “Describe Test Procedure in Plain English” 20 and then let the Productivity Test Automation System Application 30 of this invention build test script.

The subject matter of this disclosure is now described with reference to the following examples. These examples are provided for the purpose of illustration only, and the subject matter is not limited to these examples, but rather encompasses all variations which are evident as a result of the teaching provided herein.

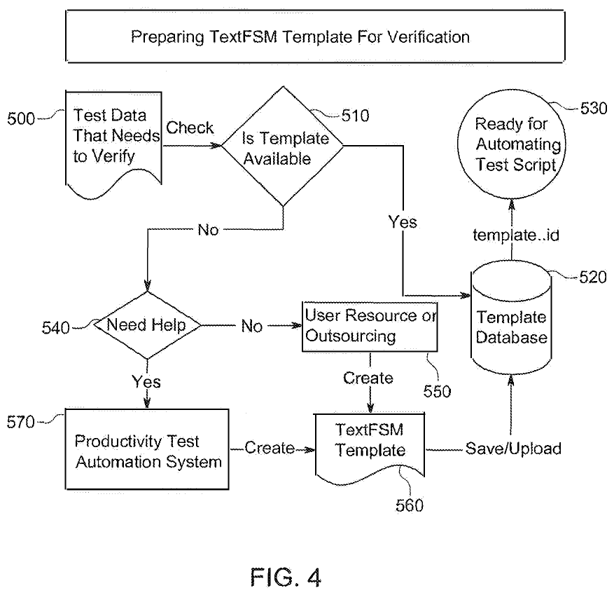

In these embodiments relating to the “Describe Test Procedure in Plain English” 20 followed by the Productivity Test Automation System Application 30 of this invention building a test script, there are certain sugggested requirements for some embodiments:
1. The test data must be human readable text.
2. A connector application programming interface must be available (e.g., FIG. 3, Connector 5). The Productivity Test Automation System Application 30 does not provide the connector application programming interface itself.
3. The user must understand his or her test data. The Productivity Test Automation System (FIG. 4, 570) will not help the user to understand his or her test data.
4. The verifying test data 500 needs to transform to a searchable table row-column data structure by using a template 510, 520. If verifying data contains multiple search tables, it needs to merge in one searchable table data structure through horizontal or vertical joint operation. Note: joint method is provided by the Productivity Test Automation System 570.
5. If the user knows how to create a template for parsing text, this step can be skipped. If the user needs help to build a template, the Productivity Test Automation System 570 will provide a method to build a parsing template in plain English.

### Part A: Preparing TextFSM Templates for Verification

FIG. 4 shows certain embodiments for preparing a TextFSM template for verification. Text searching recognition comprises several suggested processes in certain embodiments of this invention, which include that:
1. Text interpretation direction must be from left to right.
2. Processing text must be a line, not multiple lines. If a line needs to break into several parts for multiple analyses, it must append “->Continue” at the end of line. If a line has a relation with the next line, it must append “->Next” at the end of line.
3. To clarify a lookup, providing indicators would help to get accurate results.
4. A searching text needs to provide a detailed characteristic of lookup value as much
as possible.
5. A boundary text search needs to provide a starting point, a transition state, and an ending point with the next state if necessary.
6. “->Record” must append at the end of line when multiple searches are used on the same pattern or the group of patterns.
7. TextFSM also provides four options to enhance data capturing: Required, List, Fillup, or/and Filldown. Required option is a checking condition that would capture a whole record when a Required member of a record is present. List option would change the captured result into list of string data structure and append to on each match. Filldown option would help to fill in an empty captured result from previous non-empty captured result. Fillup option would help to fill in any previous empty result from current non-empty captured result.

### Creating TextFSM Templates

A number of steps are suggested for embodiments of this invention for creating a TextFSM template. Examples of such embodiments follow:

### Example 1: Providing Indicators to Help Get Accurate Results

As an example, providing indicators would help get accurate results. This example assumes user1 has the show version output below and he or she wants to create a TextFSM template to extract version.

Software version 2.3.1.a blab blab
Blab blab blab ... blab blab blab ...

A human interpretation for autogenerating a TextFSM template, first finds a value in a show version output where its “Software version” is a left sibling and “blab blab” is a right sibling. The separation between left sibling, lookup value, and right sibling is a blank space.

Based on a search criterion, user1 can arrange a first draft:

<left-sibling><blank-space><placeholder-to-parse-lookup><blank-
space><right-sibling>

Indicators:
Left-sibling: Software version
Right-sibling: blab blab
User1 substitutes actual data for left-sibling, right-sibling, and blank-space. The snippet looks similar to the one below
Software version <placeholder-to-parse-lookup>blab blab

After reviewing template documentation from the Productivity Test Automation System, user1 finds out that the version keyword can help to construct a template. To capture the value of version, a variable name must be created in order to store a value. That is var_version which is interpreted as a version variable. User1 substitutes <placeholder-to-parse-lookup> for version(var_version). The snippet looks similar to the one below:
Software version version (var_version) blab blab

After that, the Productivity Test Automation System would generate the below TextFSM template:

################################################################
################
# Template is generated by templateapp Community Edition

| # Created by | : user1 |
|---|---|
| # Email | : user1@abc_xyz.com |
| # Company | : ABC XYZ Inc. |
| # Created date | : 2022-02-01 |

################################################################
################
Value version ([0-9]\S*)
Start
\hat{ }Software version ${version} blab blab

User1 uses this generated TextFSM template to test with show version output. The result should be

| | |
|---|---|
| + --------- | + |
| \| version | \| |
| + --------- | + |
| \| 2.3.1.a | \| |
| + --------- | + |

User1 determines that the generated TextFSM template would work for parsing show version output and wants to save to file or database for later reuse.

### Example 2: Providing a Detailed Characteristic of Lookup

As an example, the following provides a detailed characteristic of lookup value as much as possible. This example assumes user1 has the show device info output below and he or she wants to create TextFSM template to parse his or her data into tabular format of the following headers: name, status, connectivity, and reboot.

| name | status | connectivity | reboot |
|---|---|---|---|
| component-1 | operational | online | 0 |
| component-2 | operational | online | 1 |
| component-3 | not running | offline | 0 |
| component-4 | error | N/A | unknown |

Applying a human interpretation for autogenerating TextFSM template includes: parsing show device info output into tabular format that would contain four columns: name, status, connectivity, and reboot. Values of Name column hold mixing letters, dash, and digits. Status column can be a word or multiple words. Connectivity column must be online, offline, or N/A. Reboot column can only be digits or_unknown. Columns separate at least one blank space. As an example:

...
“mixed_word” keyword matches a group of alphanumeric and
punctuation characters.
“words” keyword matches at least one group of alphanumeric
characters separated by space character.
“choice” keyword matches a group of specific predefined words or
phrases.
“digits” keyword matches multiple numeric characters.
...

Based on tabular data of four columns, user1 can arrange a first draft:

<name_column_placeholder><multi-
space><status_column_placeholder><multi-
space><connectivity_column_placeholder><multiple-
space><reboot_column_placeholder>

The characteristic of name_column is mixing letters, dash, and digits. After reviewing template documentation from the Productivity Test Automation System, user1 finds out mixed_word would satisfy for this case.

“mixed_word” keyword matches a group of alphanumeric and
punctuation characters.

User1 substitutes name_column_placeholder for mixed_word(var_name) and multi-space for two blank spaces. The snippet would look similar to the one below:

mixed_word(var_name) <status_column_placeholder>
<connectivity_column_placeholder> <reboot_column_placeholder>

The characteristic of status_column is a word or multiple words. User1 wants to use words(var_status) for this substitution. The snippet would be:

mixed_word(var_name) words(var_status)
<connectivity_column_placeholder> <reboot_column_placeholder>

The characteristic of connectivity_column is online, offline, or N/A. User1 think alternation matching would perform condition. User1 decides to use choice(var_connectivity, online, offline, N/A) for this substitution. The snippet would be:

mixed_word(var_name) words(var_status)
choice(var_connectivity, online, offline, N/A)
<reboot_column_placeholder>

The characteristic of reboot_column is either digits or unknown. User1 wants to use digits as a primary lookup and then combines alternative another lookup by or_flag. User1 determines to use digits(var_reboot, or_unknown) for this substitution. The snippet would be:

mixed_word(var_name) words(var_status)
choice(var_connectivity, online, offline, N/A)
digits(var_reboot, or_unknown)

Finally, user guide recommends appending->Record at the end of parsing statement will let template to parse multiple records. User1 appends “->Record” to the snippet.

mixed_word(var_name) words(var_status)
choice(var_connectivity, online, offline, N/A)
digits(var_reboot, or_unknown) −> Record

Productivity Test Automation System will generate the below TextFSM template:

################################################################
#################
# Template is generated by templateapp Community Edition

| # Created by | : user1 |
|---|---|
| # Email | : user1@abc xyz.com |
| # Company | : ABC XYZ Inc. |
| # Created date | : 2022-02-10 |

```
################################################################
################
Value module (\S*[a-zA-Z0-9]\S*)
Value description ([a-zA-Z0-9]+( [a-zA-Z0-9]+)*)
Value connectivity (online|offline|N/A)
Value reconnect (\d+|unknown)
Start
  \hat{ }module +description +connectivity +reconnect −> table
table
  \hat{ }${module} +${description} +${connectivity} +${reconnect} −>
Record
  \hat{ }name +status +connectivity +reboot −> Start
```

User1 uses this generated TextFSM template to test with show device info output. The result should be:

| | | | | |
|---|---|---|---|---|
| +------------- | +------------- | +------------- | +--------- | + |
| \| name | \| status | \| connectivity | \| reboot | \| |
| +------------- | +------------- | +------------- | +--------- | + |
| \| component-1 | \| operational | \| online | \| 0 | \| |
| \| component-2 | \| operational | \| online | \| 1 | \| |
| \| component-3 | \| not running | \| offline | \| 0 | \| |
| \| component-4 | \| error | \| N/A | \| unknown | \| |
| +------------- | +------------- | +------------- | +--------- | + |

User1 determines that the generated TextFSM template would work for parsing show device info output and wants to save to file or database for later reuse.

### Example 3: Information Necessary for a Boundary Text Search

It may be necessary to provide a starting point, a reference block, and an ending point for a boundary text search. This example assumes user1 has the show module info output below and he or she wants to create a TextFSM template to parse his or her module info text into tabular format of the following headers: module, description, connectivity, and reconnect.

| module | description | connectivity | reconnect |
|---|---|---|---|
| ------------- | ---------------- | -------------- | -------- |
| module-1 | left interface | online | 1 |
| module-2 | right interface | online | 2 |
| module-3 | middle interface | N/A | unknown |
| name | status | connectivity | reboot |
| ------------- | ---------------- | -------------- | -------- |
| component-1 | operational | online | 0 |
| component-2 | operational | online | 1 |

Applying a human interpretation for autogenerating TextFSM template comprises using show module_device info output to parse module information into tabular format that would contain four columns: module, description, connectivity, and reconnect. Values of module column hold mixing letters, dash, and digits. Description column can be a word or multiple words. Connectivity column must be online, offline, or N/A. Reconnect column can only be digits or unknown. Columns separate at least one blank space. All parsed text must be found between “module description connectivity reconnect” and “name status connectivity reboot”.

Based on a partial parsing tabular criterion, user1 can arrange a first draft:

<starting_point_placeholder>
<module_column_placeholder><multi-
space><description_column_placeholder><multi-
space><connectivity_column_placeholder><multiple-
space><reconnect_column_placeholder>
<ending_point_placeholder>

Starting point is “module description connectivity reconnect” and user1 wants to create a transition state and call it as table. As a result, user1 substitutes starting_point_placeholder with the following:

module description connectivity reconnect −> table
table

The snippet should look similar to the one below:

module description connectivity reconnect −> table
table
<module_column_placeholder><multi-
space><description_column_placeholder><multi-
space><connectivity_column_placeholder><multiple-
space><reconnect_column_placeholder>
<ending_point_placeholder>

Users want to substitute module_column, description_column, connectivity_column, and reconnect_column placeholders for mixed_word(var_module), words(var_description), choice(var_connectivity, online, offline, N/A), digits(var_reconnect, unknown). The snippet should look similar to the one below:

module description connectivity reconnect −> table
table
mixed_word(var_module) words(var_description)
choice(var_connectivity, online, offline, N/A)
digits(var_reconnect, or_unknown) −> Record
<ending_point_placeholder>

User1 substitutes ending_point_placeholder with “name status connectivity reboot”, the snippet should look similar to the one below:

module description connectivity reconnect −> table
table
mixed_word(var_module) words(var_description)
choice(var_connectivity, online, offline, N/A)
digits(var_reconnect, or_unknown) −> Record
name status connectivity reboot

User1 wants to transition the last search to the next state. In case, there is no next state except the Start state. User1 would transition ending_point to the Start state. The snippet should look similar to the one below:

module description connectivity reconnect −> table
table
mixed_word(var_module) words(var_description)
choice(var_connectivity, online, offline, N/A)
digits(var_reconnect, or_unknown) −> Record
name status connectivity reboot −> Start

Productivity Test Automation System will then generate the below TextFSM template:

#################################################################
################
# Template is generated by templateapp Community Edition

| # Created by | : user1 |
|---|---|
| # Email | : user1@abc xyz.com |
| # Company | : ABC XYZ Inc. |
| # Created date | : 2022-02-10 |

```
#################################################################
################
Value module (\S*[a-zA-Z0-9]\S*)
Value description ([a-zA-Z0-9]+([a-zA-Z0-9]+)*)
Value connectivity (online|offline|N/A)
Value reconnect (\d+|unknown)
Start
  \hat{ }module +description +connectivity +reconnect −> table
table
  \hat{ }${module} +${description} +${connectivity} +${reconnect} −>
  Record
  \hat{ }name +status +connectivity +reboot −> Start
```

User1 uses this generated TextFSM template to test with show module_device info output The result should be.

| | | | | |
|---|---|---|---|---|
| +---------- | +------------------ | +-------------- | +----------- | + |
| \| module | \| description | \| connectivity | \| reconnect | \| |
| +---------- | +------------------ | +-------------- | +----------- | + |
| \| module-1 | \| left interface | \| online | \| 1 | \| |
| \| module-2 | \| right interface | \| online | \| 2 | \| |
| \| module-3 | \| middle interface | \| N/A | \| unknown | \| |
| +---------- | +------------------ | +-------------- | +----------- | + |

User1 determines that the generated TextFSM template would work for parsing module_info in show module_device info output and wants to save to file or database for later reuse.

### Example 4: Appending “->Next” at the End of Line

If a line has a relation with the next line, it must append “->Next” at the end of the line. This example assumes user1 has the show module device info output below and he or she wants to create a TextFSM template to parse his or her module info text into tabular format of the following headers: module, description, connectivity, and reconnect. Note: if the value of module column is too long, it would break into two lines. The first line only holds the value of module and second line should start at description column position.

| module | description | connectivity | reconnect |
|---|---|---|---|
| ------------- | ---------------- | -------------- | -------- |
| module-1 | left interface | online | 1 |
| long-name-module-2 | | | |
| | right interface | online | 2 |
| module-3 | middle interface | N/A | unknown |
| name | status | connectivity | reboot |
| ------------- | ---------------- | -------------- | -------- |
| component-1 | operational | online | 0 |

Applying human interpretation for autogenerating a TextFSM template, the interpretation for this example should be similar to Example 3 with an additional condition “if the value of module column is too long, . . . ”. For this scenario, the first line only contains the value of the module, and the second line contains three columns: description, connectivity, and reconnect, and the value of description column must be left aligned with a description header. In other words, the left alignment for description column is 14 blank spaces at the beginning.

User1 wants to reuse the snippet from example 3 and arranges the module_column_with_long_value scenario. It might look similar to the below:

module description connectivity reconnect -> table
table
mixed_word(var_module) words(var_description)
choice(var_connectivity, online, offline, N/A)
digits(var_reconnect, or_unknown) −> Record
<module_column_with_long_value_placeholder>
<14-spaces-placehoder><description_column_placeholder>
<connectivity_column_placeholder> <reconnect_column_placeholder>
name status connectivity reboot -> Start

Since module_column_with_long_value is a mixed word of a line and it must be next to second line, it can be substituted with mixed_word (var_module) end ( )->Next.

module description connectivity reconnect −> table
table
mixed word(var_module) words(var_description)
choice(var_connectivity, online, offline, N/A)
digits(var_reconnect, or_unknown) −> Record
mixed_word(var_module) end( ) −> Next
<14-spaces-placehoder><description_column_placeholder>
<connectivity_column_placeholder> <reconnect_column_placeholder>
name status connectivity reboot −> Start

The 14-spaces-placeholder can be replaced by space(14_occurrence). The description, connectivity, and reconnect column placeholders should be unchanged in their layout. After substitution, it should look similar to the below:

module description connectivity reconnect −> table
table
mixed_word(var_module) words(var_description)
choice(var_connectivity, online, offline, N/A)
digits(var_reconnect, or_unknown) −> Record
mixed_word(var_module) end( ) −> Next
space(14_occurrence) words(var_description)
choice(var_connectivity, online, offline, N/A)
digits(var_reconnect, or_unknown) −> Record
name status connectivity reboot −> Start

Productivity Test Automation System will then generate the below TextFSM template:

################################################################
################
# Template is generated by templateapp Community Edition

| | : user1 |
|---|---|
| # Email | : user1@abc xyz.com |
| # Company | : ABC XYZ Inc. |
| Created date | : 2022-02-14 |

```
# ###############################################################
################
Value module (\S* [a-zA-Z0-9] \S*)
Value description ([a-zA-Z0-9]+( [a-zA-Z0-9]+) *)
Value connectivity (online | offline | N/A)
Value reconnect (\d+ |unknown)
Start
  \hat{ }module +description +connectivity +reconnect −> table
table
  \hat{ }${module} +${ description} +${connectivity} +${reconnect} −>
Record
  \hat{ }${ module}$$ −> Next
  \hat{ } {14} ${ description} +${ connectivity} +${reconnect} −> Record
  \hat{ }name +status +connectivity +reboot −> Start
```

User1 uses this generated TextFSM template to test with show module_device info output. The result should be:

| | | | | |
|---|---|---|---|---|
| +-------------------- | +------------------ | +-------------- | +----------- | + |
| \| module | \| description | \| connectivity | \| reconnect | \| |
| +-------------------- | +------------------ | +-------------- | +----------- | + |
| \| module-1 | \| left interface | \| online 1 | \| 1 | \| |
| \| long-name-module-2 | \| right interface | \| online | \| 2 | \| |
| \| module-3 | \| middle interface | \| N/A | \| unknown | \| |
| +-------------------- | +------------------ | +-------------- | +----------- | + |

+

User1 determines that the generated TextFSM template would work for parsing module_info in show module_device info output and wants to save to file or database for later reuse.

### Example 5: Appending “->Continue” at the End of Line

If a line needs to break into several parts for multiple analyses, it must append “->Continue” at the end of the line. This example assumes user1 has the show food output below in this example and he or she would want to create a TextFSM template to parse his or her list of food text into tabular format of the following headers: index, kind, count, and group. Group column contains a list of food and it limits three foods per line. Any over quantity of food count must continue to the next line with left-alignment of group column. Note: group column can have an empty cell. The list of food is separated by a comma and the last food will not end with a comma.

| Index | Kind | Count | Group |
|---|---|---|---|
| 1 | Vegetables | 1 | Corn |
| 2 | Fruits | 5 | Orange, Peach, Cherry, |
| | | | Mango, Grape |
| 3 | Breads | 0 | |
| 4 | Snack | 7 | Potato, Tapioca, Muffins, |
| | | | Pita, Sunflower, Plantain, |
| | | | Pretzels |
| 5 | Meat | 2 | Chicken, Pork |
| 6 | Citrus | 3 | Orange, Citron, Clementine |

Applying human interpretation for autogenerating a TextFSM template, then parsing show food output into tabular format would contain four columns: index, kind, count, and group. Index column can be digits. Kind column can be a word. Count column can be digits. Group column can be a list of words. Columns separate at least one blank space. All parsed text must be found after “Index Kind Count Group” text.

The different cases include:
Case 1: group column can have an empty cell. In other words, capturing data on index, type, and count columns should be good enough for this case.
Case 2: group column contains only one food.
Case 3: group column contains two foods. The last food will not end with a comma.
Case 4: group column contains three foods. The last food will not end with a comma.
Case 5: group column contains four foods. Because of limiting three foods per line, group column needs to be arranged into two cells: the first cell contains three foods with a comma ending, the second cell contains one food.
Case 6: group column contains five foods. Group column needs to be arranged into two cells: the first cell contains three foods with a comma ending, the second cell contains two foods.
Case 7: group column contains six foods. Group column needs to be arranged into two cells: the first cell contains three foods with a comma ending, the second cell contains three foods.
Case 8: group column contains seven foods. Group column needs to be arranged into three cells: the first and second cell contain three foods with a comma ending, the third cell contains one food. The pattern of this case is similar to case 5. As a result, this case is a repeat scenario of case 5.
Case 9: group column contains eight foods. Group column needs to be arranged into three cells: the first and second cell contain three foods with a comma ending, the third cell contains two foods. The pattern of this case is similar to case 6. As a result, this case is a repeat scenario of case 6.
Case 10: group column contains nine foods. Group column needs to be arranged into three cells: the first and second cell contain three foods with a comma ending, the third cell contains three foods. The pattern of this case is similar to case 7. As a result, this case is a repeat scenario of case 7.

Since case 8, 9, and 10 are the repeat scenarios, they can be omitted. As a result, total cases are:
Case 1: group column can have an empty cell. In other words, capturing data on index, type, and count columns should be good enough for this case.
Case 2: group column contains only one food.
Case 3: group column contains two foods. The last food will not end with a comma.
Case 4: group column contains three foods. The last food will not end with a comma.
Case 5: group column contains four foods. Because of limiting three foods per line, group column needs to be arranged into two cells: the first cell contains three foods with a comma ending, the second cell contains one food.
Case 6: group column contains five foods. Group column needs to be arranged into two cells: the first cell contains three foods with a comma ending, the second cell contains two foods.
Case 7: group column contains six foods. Group column needs to be arranged into two cells: the first cell contains three foods with a comma ending, the second cell contains three foods.

Since the group column of case 5, 6, and 7 split into two cells where the first cell is a repeat pattern of case 4, the second cell of those cases can be analyzed as:
Case 5: capture a continuing 4th food where its captured value is on a left alignment (i.e., at least 20 blank spaces).
Case 6: perform searching for 4th food, and then capture 5th food.
Case 7: perform searching for 4th and 5th foods, and then capture 6th food.

User1 wants to rephrase all 7 cases for more readable content. Those cases can be analyzed as:
Case 1: only captures data on index, type, and count columns.
Case 2: capture index, type, count, group columns where group column has exacted one food.
Case 3: perform searching for index, type, count, and first food of group column, and then capture 2nd food.
Case 4: perform searching for index, type, count, and 1st and 2nd foods of group column, and then capture 3rd food.
Case 5: capture a continuing 4th food where its captured value is on a left alignment (i.e., at least 20 blank spaces).
Case 6: perform searching for 4th food, and then capture 5th food.
Case 7: perform searching for 4th and 5th foods, and then capture 6th food.

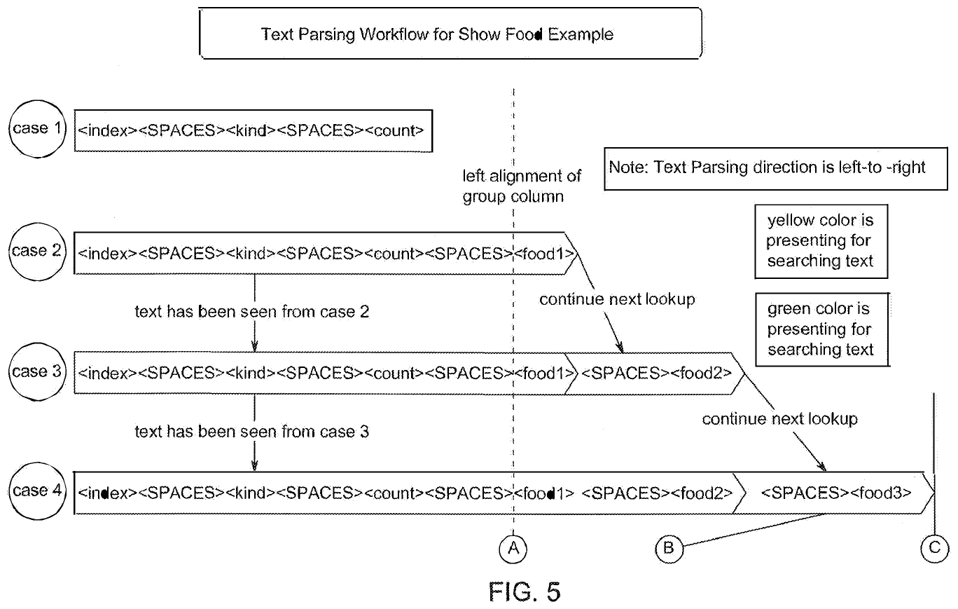

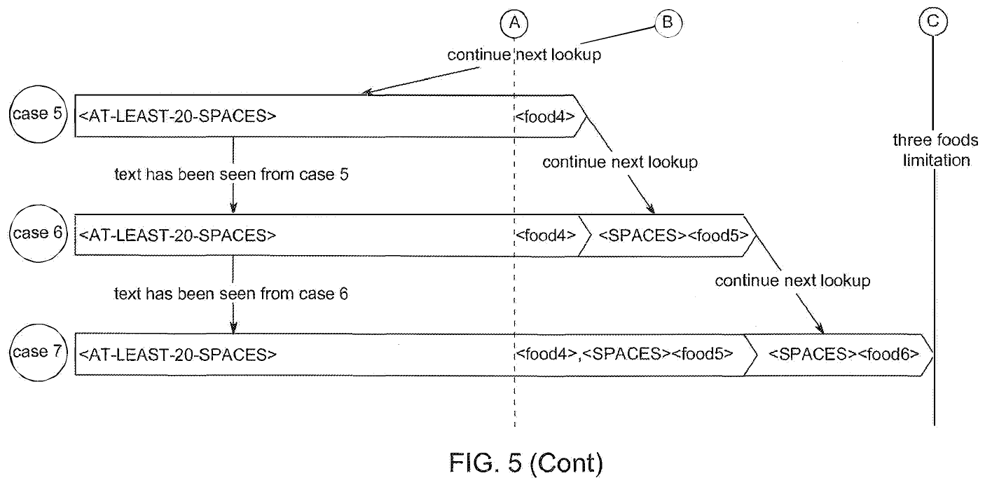

FIG. 5 shows text parsing workflow for a show food example. After reviewing a drawing, user1 wants to apply some context for those 7 cases in the figure.

Case 1 captures data on index, type, and count columns:

<index_column><SPACES><kind_column><SPACES><count_column>
<end_of_line>

Values of index column are digit(s). Values of kind column are word. Values of count column are digit(s). User1 decides SPACES are two blank spaces. User1 arranges a draft snippet for this case as:
digits ( )word ( )digits ( )<end_of_line>

The snippet needs to capture data. User1 adds variables to those keywords accordingly. The snippet should look similar to the one below:
digits (var_index) word (var_kind) digits (var_count)<end_of_line>

User1 wants to substitute end_of_line for end keyword. The snippet should be:
digits (var_index) word (var_kind) digits (var_count) end (space)

Case 2: capture index, type, count, group columns where group column has exacted one food

<index_column><SPACES><kind_column><SPACES><count_column><SPACES><grou
p_column> −> Continue

After substitution, the snippet for case 2 should look similar to the one below:

digits(var_index) word(var_kind) digits(var_count) word(var_group)
−> Continue

Case 3: perform searching for index, type, count, and first food of group column, and then capture 2^{nd} food. “Perform search for index, type, count and first food of group column” is equivalent a searched text in case 2 without variable.

A searched text of case 2: digits( ) word( ) digits( ) word( )
A capturing 2^{nd} food: word(var_group)

After substitution, the snippet for case 3 should look similar to the one below:
digits ( )word ( )digits ( )word ( ), word (var_group)->Continue

Case 4: perform searching for index, type, count, and 1^{st} and 2^{nd} foods of group column, and then capture 3rd food:

A searched text of case 3: digits( ) word( ) digits( ) word( ), word( )
A capturing 3^{rd} food: word(var_group)

The snippet for case 4 should look similar to the one below:

digits( ) word( ) digits( ) word( ), word( ) , word(var_group) −>
Continue

Case 5: capture a continuing 4^{th} food where its captured value is on a left alignment (i.e., at least 20 blank spaces):

At least 20 blank spaces: space(at_least_20_occurrence)
A capturing 4^{th} food: word(var_group)

The snippet for case 5 should look similar to the one below:
space (at_least_20_occurrence) word (var_group)->Continue

Case 6: perform searching for 4th food, and then capture 5th food:

A searched text of case 5: space (at_least_20_occurrence) word( )
A capturing 5^{th} food: word (var_group)

The snippet for case 6 should look similar to the one below:
space (at_least_20_occurrence) word ( ) word (var_group)->Continue

Case 7: perform searching for 4th and 5th foods, and then capture 6th food:

A searched text of case 6: space (at_least_20_occurrence) word( ),
word( )
A capturing 6^{th} food: word (var_group)

The snippet for case 7 should look similar to the one below:

space(at_least_20_occurrence) word( ), word( ) , word(var_group) −>
Continue

User1 reorganizes the snippet. This should look similar to the one below

digits(var_index) word(var_kind) digits(var_count) end(space)
digits(var_index) word(var_kind) digits(var_count) word(var_group)
−> Continue
digits( ) word( ) digits( ) word( ) , word(var_group) −> Continue
digits( ) word( ) digits( ) word( ) , word( ), word(var_group) −>
Continue
space (at_least_20_occurrence) word(var_group) −> Continue
space (at_least_20_occurrence) word( ), word(var_group) −> Continue
space (at_least_20_occurrence) word( ), word( ), word(var_group) −>
Continue

User1 wants the captured result of group variable as a list of string instead of string. In this situation, user1 needs to insert meta_data_list option to every word (var_group). After substitution, the snippet should look similar to the one below:

digits(var index) word(var_kind) digits(var_count) end(space)
digits(var_index) word(var_kind) digits(var_count) word(var_group,
meta_data_list) −> Continue
digits( ) word( ) digits( ) word( ), word(var_group, meta_data_list) −>
Continue
digits( ) word( ) digits( ) word( ), word( ), word(var_group,
meta_data_list) −> Continue
space(at_least_20_occurrence) word(var_group, meta data_list) −>
Continue
space(at_least_20_occurrence) word( ), word(var_group,
meta_data_list) −> Continue
space(at_least_20_occurrence) word( ), word( ), word(var_group,
meta_data_list) −> Continue

User1 understands that all parsed text must be found after “Index Kind Count Group” text. User1 creates a specific section to begin for parsing. The snippet should look similar to the below:

Index Kind Count Group −> table
table
digits(var_index) word(var_kind) digits(var_count) end(space)
digits(var_index) word(var_kind) digits(var_count) word(var_group,
meta_data_list) −> Continue
digits( ) word( ) digits( ) word( ), word(var_group, meta_data_list) −>
Continue
digits( ) word( ) digits( ) word( ), word( ), word(var_group,
meta_data_list) −> Continue
space(at_least_20_occurrence) word(var_group, meta_data_list) −>
Continue
space(at_least_20_occurrence) word( ), word(var_group,
meta_data_list) −> Continue
space(at_least_20_occurrence) word( ), word( ), word(var_group,
meta_data_list) −> Continue

User1 understands that the process of parsing text is left-to-right direction and user1 doesn't want to miss any captured data. User1 would assert the criteria that begins recording result when template sees digits at the beginning of the line. User1 wants to place it just after table transition state. The snippet should be:

Index Kind Count Group −> table
table
digits( ) −> Continue. Record
digits(var_index) word(var_kind) digits(var_count) end(space)
digits(var_index) word(var_kind) digits(var_count) word(var_group,
meta_data_list) −> Continue
digits( ) word( ) digits( ) word( ) , word(var_group, meta_data_list) −>
Continue
digits( ) word( ) digits( ) word( ) , word( ) , word(var_group,
meta_data_list) −> Continue
space(at_least_20_occurrence) word(var_group, meta_data_list) −>
Continue
space(at_least_20_occurrence) word( ), word(var_group,
meta_data_list) −> Continue
space(at_least_20_occurrence) word( ), word( ), word(var_group,
meta_data_list) −> Continue

Productivity Test Automation System will then generate the below TextFSM template:

######################################################################
##########
# Template is generated by templateapp Community Edition

| # Created by | : user1 |
|---|---|
| # Email | : user1@abc_xyz.com |
| # Company | : ABC XYZ Inc. |
| # Created date | : 2022-02-16 |

```
######################################################################
##########
Value index (\d+)
Value kind ([a-zA-Z0-9]+)
Value total (\d+)
Value List group ([a-zA-Z0-9]+)
Start
  \hat{ }Index Kind +Count +Group −> table
table
  \hat{ }\d+ −> Continue.Record
  \hat{ }$ {index} +${kind} +${total} *$$
  \hat{ }$ {index} +${kind} +${total} +${group} −> Continue
  \hat{ }\d+ +[a-zA-Z0-9]+ +\d+ +[a-z-Z0-9]+, ${group} −> Continue
  \hat{ }\d+ +[a-zA-Z0-9]+ +\d+ +[a-z-Z0-9]+, [a-zA-Z0-9]+, ${group} −>
  Continue
  \hat{ } {20,} $ {group} −> Continue
  \hat{ } {20,} [a-zA-Z0-9]+, ${group} −> Continue
  \hat{ } {20,} [a-zA-Z0-9]+, [a-zA-Z0-9]+, ${group} −> Continue
```

User1 uses this generated TextFSM template to test with show food output. The result should be:

| Index | Kind | Total | Group |
|---|---|---|---|
| 1 | Vegetables | 1 | [‘Corn’] |
| 2 | Fruits | 5 | [‘Orange’, ‘Peach’, ‘Cherry’, |
| | | | ‘Mango’, ‘Grape’] |
| 3 | Breads | 0 | [ ] |
| 4 | Snack | 7 | [‘Potato’, ‘Tapioca’, ‘Bean’, |
| | | | ‘Pita’, ‘Tortilla’, ‘Plantain’, |
| | | | ‘Kale’] |
| 5 | Meat | 2 | [‘Chicken’, ‘Pork’] |
| 6 | Citrus | 3 | [‘Orange’, ‘Citron’, ‘Clementine’] |

User1 determines that the generated TextFSM template would work for “show food” output and wants to save to file or database for later reuse.

### Example 6: Using a Required Option

Required option is a checking condition that would capture a whole record when a Required member of a record is present. This example only demonstrates the usage of Required option. This example assumes user1 has the show system output below and he or she wants to create TextFSM template to parse into tabular format of the following headers: name, description, and status.

| Name | Description | Status |
|---|---|---|
| module1 | left fan | on |
| module2 | | unknown |
| module3 | cooler | on |

Based on output format, user1 can arrange the snippet that looks similar to the one below:

Name Description Status −> table
table
word(var_name) words(var_description) word(var_status) −>
Record
word(var_name) space(at_least_16_occurrence) word(var_status) −
> Record

The generated template should be:

################################################################
################
# Template is generated by templateapp Community Edition

| # Created by | : User1 |
|---|---|
| # Email | : user1@abc_xyz@.com |
| # Company | : ABC XYZ Inc. |
| # Created date | : 2022-02-21 |

```
################################################################
################
Value name ([a-zA-Z0-9]+)
Value description ([a-zA-Z0-9]+( [a-zA-Z0-9]+)*)
Value status ([a-zA-Z0-9]+)
Start
  \hat{ }Name +Description +Status −> table
table
  \hat{ }${name} +${description} +${status} −> Record
  \hat{ }${name} {16,} +${status} −> Record
```

The parsed result should be:

| | | | |
|---|---|---|---|
| +--------- | +------------- | +--------- | + |
| \| name | \| description | \| status | \| |
| +--------- | +------------- | +--------- | + |
| \| module1 | \| left fan | \| on | \| |
| \| module2 | \| | \| unknown | \| |
| \| module3 | \| cooler | \| on | \| |
| +--------- | +------------- | +--------- | + |

If user1 wants to parse the show system output to exclude any record without description or none description, user1 can add Required option for description column. The snippet should be:

Name Description Status −> table
table
word(var_name) words(var_description, meta_data_required)
word(var_status) −> Record
word(var_name) space(at_least_16_occurrence) word(var_status) −
> Record

The generated template should be:

################################################################
################
# Template is generated by templateapp Community Edition

| # Created by | : User1 |
|---|---|
| # Email | : user1@abc_xyz@.com |
| # Company | : ABC XYZ Inc. |
| # Created date | : 2022-02-21 |

```
################################################################
################
Value name ([a-zA-Z0-9]+)
Value Required description ([a-zA-Z0-9]+( [a-zA-Z0-9]+) *)
Value status ([a-zA-Z0-9]+)
Start
  \hat{ }Name +Description +Status −> table
table
  \hat{ }$ {name} +${description} +${status} −> Record
  \hat{ }$ {name} {16,} +${status} −> Record
```

The parsed result should be:

| | | | |
|---|---|---|---|
| +--------- | +------------ | +--------- | + |
| \| name | description | \| status | \| |
| +--------- | +------------ | +--------- | + |
| \| module1 | \| left fan | \| on | \| |
| \| module3 | \| cooler | \| on | \| |
| +--------- | +------------ | +--------- | + |

### Example 7: Using a List Option

List option would change the captured result into a list of string data structure and append to on each match. This example only demonstrates the usage of List option. This example assumes user1 has the show items output below and he or she wants to create TextFSM template to capture a list of items.
items: left fan, right fan

Based on output format, user1 can arrange the snippet that looks similar to the one below:

items: words(var_items, meta_data_list) −> Continue
items: words( ), words(var_items, meta_data_list)

The generated template should be:

################################################################
################
# Template is generated by templateapp Community Edition

| # Created by | : User1 |
|---|---|
| # Email | : user1@abc xyz@.com |
| # Company | : ABC XYZ Inc. |
| # Created date | : 2022-02-22 |

```
################################################################
################
Value List items ([a-zA-Z0-9]+( [a-zA-Z0-9]+)*)
Start
  \hat{ }items: ${items} −> Continue
  \hat{ }items: [a-zA-Z0-9]+( [a-zA-Z0-9]+)*, ${items}
```

The parsed result should be:

| | |
|---|---|
| +--------------------------- | + |
| \| items | \| |
| +--------------------------- | + |
| \| [‘left fan’, ‘right fan’] | \| |
| +--------------------------- | + |

### Example 8: Using a Filldown Option

The Filldown option would help to fill in an empty captured result from a previous non-empty captured result. This example only demonstrates the usage of Filldown option. This example assumes user1 has the show module info output below and he or she wants to create TextFSM template to capture data for module, unit, and status columns.

| Module | Unit | Status |
|---|---|---|
| cooler | front cooler C1 | on |
| | rear cooler C2 | on |
| air | left fan F1 | on |
| | right fan F2 | on |
| | misc fan F3 | off |

Based on output format, user1 can arrange the snippet that looks similar to the one below:

Module Unit Status -> table
table
word(var_module) words(var_unit) word(var_status) −> Record
space(at_least_8_occurrence) words(var_unit) word(var_status)
−> Record
EOF

The generated template should be:

################################################################
################
# Template is generated by templateapp Community Edition

| # Created by | : User1 |
|---|---|
| # Email | : user1@abc xyz@.com |
| # Company | : ABC XYZ Inc. |
| # Created date | : 2022-02-22 |

```
################################################################
################
Value module ([a-zA-Z0-9]+)
Value unit ([a-zA-Z0-9]+( [a-zA-Z0-9]+)*)
Value status ([a-zA-Z0-9]+)
Start
  \hat{ }Module +Unit +Status −> table
table
  \hat{ }${module} +${unit} +${status} −> Record
  \hat{ } {8,} +${unit} +${status} −> Record
EOF
```

The parsed result should be:

| | | | |
|---|---|---|---|
| +-------- | +----------------- | +-------- | + |
| \| module | \| unit | \| status | \| |
| +-------- | +----------------- | +-------- | + |
| \| cooler | \| front cooler C1 | \| on | \| |
| \| | \| rear cooler C2 | \| on | \| |
| \| air | \| left fan F1 | \| on | \| |
| \| | \| right fan F2 | \| on | \| |
| \| | \| misc fan F3 | \| off | \| |
| +-------- | +----------------- | +-------- | + |

User1 understands that module column is a category name for module and its direction is top-to-bottom. User1 wants to include Filldown option to handle this case. The snippet should be:

Module Unit Status −> table
table
word(var_module, meta_data_filldown) words(var_unit)
word(var_status) −> Record
space(at_least_8_occurrence) words(var_unit) word(var_status)
−> Record
EOF

The generated template should be:

################################################################
################
# Template is generated by templateapp Community Edition

| # Created by | : User1 |
|---|---|
| # Email | : user1@abc_xyz@.com |
| # Company | : ABC XYZ Inc. |
| # Created date | : 2022-02-22 |

```
################################################################
################
Value Filldown module ([a-zA-Z0-9]+)
Value unit ([a-zA-Z0-9]+( [a-zA-Z0-9]+)*)
Value status ([a-zA-Z0-9]+)
Start
  \hat{ }Module +Unit +Status −> table
table
  \hat{ }${module} +${unit} +${status} −> Record
  \hat{ } {8,} +${unit} +${status} −> Record
EOF
```

The parsed result should be:

| module | unit | status |
|---|---|---|
| cooler | front cooler C1 | on |
| cooler | rear cooler C2 | on |
| air | left fan F1 | on |
| air | right fan F2 | on |
| air | misc fan F3 | off |

### Example 9: Using a Fillup Option

The Fillup option would help to fill in any previous empty result from current non-empty captured result. This example only demonstrates the usage of Fillup option. This example assumes user1 has the show miscellaneous output below and he or she wants to create TextFSM template to capture data for column1, column2, and column3 columns.

| Column1 | Column2 | Column3 |
|---|---|---|
| AAbbcc | 123456 | +−*/\′ |

Based on output format, user1 can arrange the snippet that looks similar to the one below:

Column1 Column2 Column3 -> table
table
letters (var_col1) end (space) −> Record
space (repetition_10_12) digits (var_col2) end (space) −> Record
space (repetition_22_24) punctuations (var_col3) end (space) −>
Record
EOF

The generated template should be:

################################################################
################
# Template is generated by templateapp Community Edition

| # Created by | : User1 |
|---|---|
| # Email | : user1@abc_xyz.com |
| # Company | : ABC XYZ Inc. |
| # Created date | : 2022-02-24 |

```
################################################################
################
Value col1 ([a-zA-Z]+)
Value col2 (\d+)
Value col3 ([!\″#$%&\′( )*+,-./:;<=>?@\[\\\]]\hat{ }_‘{|}~]+)
Start
  \hat{ }Column1 +Column2 +Column3 −> table
table
  \hat{ }$ {col1} *$$ −> Record
  \hat{ } {10,12} ${col2} *$$ −> Record
  \hat{ } {22,24} ${col3} *$$ −> Record
EOF
```

The parsed result should be:

| col1 | col2 | col3 |
|---|---|---|
| AAbbcc | 123456 | +-*/\’ |

User1 wants to add fillup option for column2 and column3. The snippet should be:

Column1 Column2 Column3 −> table
table
letters(var_col1) end(space) −> Record
space(repetition_10_12) digits(var_col2, meta_data_fillup)
end(space) −> Record
space(repetition_22_24) punctuations(var_col3, meta_data_fillup)
end(space) −> Record
EOF

The generated template should be:

################################################################
################
# Template is generated by templateapp Community Edition

| # Created by | : User1 |
|---|---|
| # Email | : user1@abc_xyz.com |
| # Company | : ABC XYZ Inc. |
| # Created date | : 2022-02-24 |

```
################################################################
################
Value col1 ([a-zA-Z]+)
Value Fillup col2 (\d+)
Value Fillup col3 ([!\″#$%&\′( )*+,-./:;<=>?@\[\\\]]\hat{ }_‘{|}~]+)
Start
  \hat{ }Column1 +Column2 +Column3 −> table
table
  \hat{ }$ {col1} *$$ −> Record
  \hat{ } {10,12} ${col2} *$$ −> Record
  \hat{ } {22,24} ${col3} *$$ −> Record
EOF
```

The parsed result should be:

| col1 | col2 | col3 |
|---|---|---|
| AAbbcc | 123456 | +-*/\’ |
| | 123456 | +-*/\’ |
| | | +-*/\’ |

### Using Template Keywords

Keywords that are used for generating template are divided into five types: common, alternation, data, symbol, and position keywords.

Common Keywords are:
“anything” keyword matches any character.
“something” keyword matches at least one character.
“something_but” keyword matches zero or at least one character.
“everything” keyword matches all characters.
“space” keyword matches a blank space character.
“spaces” keyword matches multiple blank spaces.
“non_space” keyword matches a non-blank space character.
“non_spaces” keyword matches multiple non-blank space characters.
“whitespace” keyword matches a word divider such as space, tab, newline, and more.
“whitespaces” keyword matches multiple word dividers such as space, tab, newline, and more.
“non_whitespace” keyword matches any character which is not a whitespace character.
“non_whitespaces” keyword matches multiple characters which are not whitespace characters.
“punctuation” keyword matches punctuation.
“punctuations” keyword matches multiple punctuations.
“non_punctuation” keyword matches a non-punctuation.
“non punctuations” keyword matches multiple non-punctuation.
“letter” keyword matches an alphabetical character.
“letters” keyword matches multiple alphanumeric characters.
“word” keyword matches a group of alphanumeric characters.
“words” keyword matches at least one group of alphanumeric characters separating by a blank space character.
“mixed_word” keyword matches a group of alphanumeric and punctuation characters.
“mixed words” keyword matches at least one group of alphanumeric and punctuation characters separating by a blank space character.
“phrase” keyword match at least two words separating by a blank space character.
“mixed_phrase” keyword matches at least two mixed-word separating by a blank space character.
“hexadecimal” keyword matches a hexadecimal number.
“octal” keyword matches an octal number.
“binary” keyword matches a binary number.
“digit” keyword matches a numeric character.
“digits” keyword matches multiple numeric characters.
“number” keyword matches numeric character(s) plus one dot divider if necessary.
“signed_number” keyword matches number with or without plus or minus sign.
“mixed number” keyword matches other presentation of number.
“datetime” keyword matches a datetime per provided format.
“mac_address” keyword matches six pairs of hexadecimals separating by column, dash, or space.
“ipv4_address” keyword matches four octets starting from 0 to 255 separating by dot.
“ipv6_address” keyword matches at least two groups of four-hexadecimal separating by column.
“version” or “semantic_version” keyword matches a group of alphanumeric which may separate by dot or hyphen/parenthesis where first character must be a numeric.
“interface” keyword matches a group of mixing alphanumeric, hyphen, dash, forward flash, and/or dot which must start with letters and must end with digit.

Alternation Keywords: “choice” keyword matches a group of specific predefined words or phrases.

Data Keywords: “data” keyword formats any characters to regular data.

Symbol Keywords: “symbol” keyword present naming notation instead of symbolic figure.

Position Keywords: “start” keyword tells the search must begin from here; and “end” keyword tells the search must stop from here.

### Keyword Format

Keyword format is: keyword(var_flag, meta_data_flag, or_flag, word_bound_flag, repetition_flag, occurrence_flag, raw_flag).

Var Flag: is used to capture and store value to a variable. The format is “var_” prefix and then followed by variable name. For example, word(var_device_name) captures a word and store captured value into device_name variable.

Meta_data_flag: is the assistant option for var_flag to define the captured variable characteristic to perform addition task per request. The format is “meta_data_” and then follow by Required, List, Filldown, and/or Fillup. Required option would let template parse and capture a whole record when a Required member of a record is present. List option would let template capture value and store in variable as a list and append to on each match. Filldown option would let template help to fill an empty captured result from previous non-empty captured result. Fillup option would let template help to fill any previous empty result from current non-empty captured result.

Or Flag: is used to combine other common keywords or data to get more possible matching. The format is “or_” prefix and then followed by common keyword or data. For example, ipv4_address(or_ipv6_address) matches IPv4 address or IPv6 address data.

Word Bound Flag: is used to perform word checking. The format is word_bound_left, word_bound_right, or word_bound. For example, digits(word_bound) only matches digit(s) and does not match digit(s) with prepended letter and/or appended letter. In other words, digits(word_bound) matches 5, 0.5, or 0.5, but doesn't match x5, 5x, or x5x. In addition, word_bound_left performs left word checking; word_bound_right performs right word checking; and word_bound performs left and right word checking.

Repetition Flag: is used to match multiple occurrences. The format is repetition_k, repetition_m_, repetition_n, or repetition_m_n. For example, letter(repetition_3_8) matches at least three and at most eight letters. Thus, repetition_k matches exact k occurrences; repetition_m_matches at least m occurrences; repetition_n matches at most n occurrences; and repetition_m_n matches at least m occurrences and at most n occurrences.

Occurrence Flag: is used to match multiple occurrences. The format is 0_or_1_occurrence, 0_or_1_group_occurrence, k_or_more_occurrence, k_or_more_group_occurrence, at_least_m_occurrence, at_least_m_group_occurrence, at_most_n_occurrence, at_most_n_group_occurrence, k_occurrence, or k_group_occurrence. For example, digit(3_occurrence) matches exactly three digits. In addition, 0_or_1_occurrence does not match or matches a single occurrence; 0_or_1_group_occurrence does not match or matches a single group of occurrences; k_or_more_occurrence matches at least k occurrences; K_or_more_group_occurrence matches at least k group of occurrences; at_least_m_occurrence matches at least m occurrences; at_least_m_group_occurrence matches at least m group of occurrences; at_most_n_occurrence matches at most n occurrences; at_most_n_group_occurrence matches at most n group of occurrences; k_occurrence matches exact k occurrences; and k_group_occurrence matches exact k group of occurrences.

For example, digit(var_v1, or_N/A, 3_occurrence) is interpreted as matching exact three digits or N/A and stores captured value in v1 variable.

### Part B: Preparing Test Resources

Test resources can be stored either as a file or in a database. Test resources often contain two main sections: devices and test cases. The devices section contains the credential of the device and Productivity Test Automation System application lets user fill in or modify later when user executes test script. The test cases section contains the reference of configuration script or interactive command line. The test cases section can be edited as a placeholder. The format of the test cases section is:

```
devices:
  device1: placeholder_for_user_to_fill_device_credential
  device2: placeholder_for_user_to_fill_device_credential
testcases:
  tc_1:
    cfg_script1: |-
      blab blab
      blab blab
    cfg_script2: |-
      blab blab
      blab blab blab
    cmdline1: “show device info”
    interact_cmdline2 :
      - [“cmdline”, “matching_pattern”]
      - [“data_1”, “matching_pattern_1”]
      ...
      - [“data_n”, “matching_pattern_n”]
  tc_2:
    cfg_script1: |-
      blab blab
      blab blab
  tc_3:
    bring_down_cfg: | -
      bring component-2 down
      blab blab
    bring_up_cfg: | -
      bring component-2 up
      blab blab
    script_builder:
      class_name: DeviceConnectivityTC
      test_precondition: precondition
      test_bring_down_and_verify_peer_component_down: |-
        Bring one component of device1 down and verify component
and its peer component are down
      test_bring_up_and verify_peer_component_up: | -
        Bring one component of device1 up and verify component
and its peer component are up
```

### Part C: Describing Test Procedure

The Describe-Get-System Rules (“DGS”) should provide a general process for end-users and should keep the process as simple as possible.

### The DGS Generalization Rule

The generalization rule is described further here. Assuming there is a voice search dictionary application that lets users look for word definition by speech recognition, after a user requests to use the voice search service, the application may reply with the following:
Hello, this is a digital voice search dictionary application. Would you pronounce your word?

If a user has proper and accurate pronunciation spelling, the application would quickly provide the right answer. However, the application might need to make more enhancement or improvement for accent speaking, speech impairment, or speech disorder users. In worst case scenario, if the application cannot recognize the pronunciation spelling, it might ask more questions to gather enough information to provide the correct answer. As a result, this application may be more efficient for particular users.

To apply the generalization rule for users including regular, accent speaking, speech disorder, or speech impairment users, the reply greeting might be:
Hello, this is a digital voice search dictionary application. Would you pronounce your word and spell each letter?

Speech recognition features might or might not recognize word pronunciation spelling for all users. However, with the support of “spelling each letter” describing process, the application could reply the correct answer for speech difficulty users on the first try. In conclusion, the generalization describing rule should be recommended as the best practice for Describe-Get-System serving all users.

### Simplification Rule

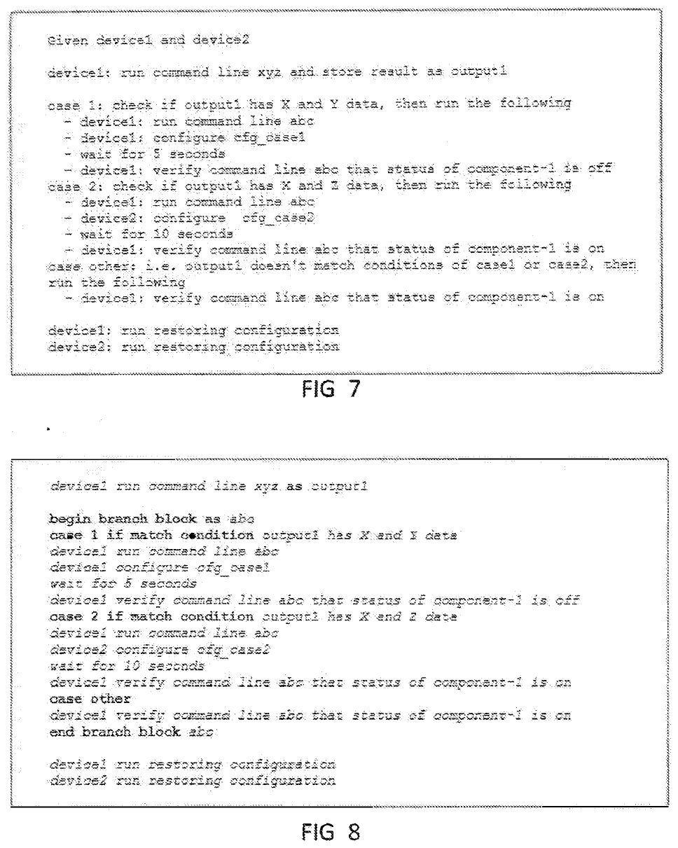

FIG. 7 describes a complex test scenario. FIG. 8 describes a possible solution for the scenario described in FIG. 7. Users might be satisfied with this solution shown in FIG. 8. However, if there is another alternative method that can simplify the describing process or make the describing solution clearer, it could be advantageous to try them out. To be able to perform this alternative describing method, YAML can help because YAML (i.e., Yet Another Markup Language) is a human-readable data-serialization language which is often used for writing configuration files. To apply this, first organize significant data from the test scenario similarly to the following:

Line 1 - device1: run command line xyz and store result as output1
Line 2 - case 1: check if output1 has X and Y data, then run the
following ... its sub-block
Line 3 - case 2: check if output1 has X and Z data, then run the
following ... its sub-block
Line 4 - case other: i.e., outputl doesn't match conditions of case
1 or case 2, then run the following ... its sub-block
Line 5 - device1: run restoring configuration
Line 6 - device2: run restoring configuration

Next, transform that workflow to first draft YAML format as the following:

- placeholder_for_line1
- placeholder_for_line2
- placeholder_for_line3
- placeholder_for_line4
- placeholder_for_line5
- placeholder_for_line6

Finally, substitute accordingly all placeholders as the following: Line 1 consists of three parts: command line action, saving result (i.e., assigning action), and name of result. It can be arranged as the following:
assignment:
   output1: device1 run command line xyz

After replacing placeholder_for_line1, it should look like the one below:

- assignment:
output1: device1 run command line xyz
- placeholder_for_line2
- placeholder_for_line3
- placeholder_for_line4
- placeholder_for_line5
- placeholder_for_line6

Line 5 and 6 are command line actions and they are actually instructions. They can be arranged as the following:

instruction: device 1 run restoring configuration
instruction: device 2 run restoring configuration

After replacing placeholder_for_line_5 and placeholder_for_line6, the YAML layout should look like the one below:

- assignment:
output1: device1 run command line xyz
- placeholder_for_line2
- placeholder_for_line3
- placeholder_for_line4
- instruction: device 1 run restoring configuration
- instruction: device 2 run restoring configuration

Line 2 is a conditional block and its sub-block is a group of command line action or a group of instructions. It can be arranged as the following:

```
if case1: # name of the first conditional block
  condition: output1 has X and Y data
  instructions:
    - device1 run command line abc
    - device1 configure cfg_case1
    - wait for 5 seconds
    - device1 verify command line abc that status of component-1
is off
```

After replacing placeholder_for_line_2, the YAML layout should look like the one below

```
- assignment:
  output1: device1 run command line xyz
- if_case1: # name of the first conditional block
  condition: output1 has X and Y data
  instructions:
    - device1 run command line abc
    - device1 configure cfg_case1
    - wait for 5 seconds
    - device1 verify command line abc that status of
component-1 is off
- placeholder_for_line3
- placeholder_for_line4
- instruction: device 1 run restoring configuration
- instruction: device 2 run restoring configuration
```

Line 3 is a conditional block and it can be arranged as the following:

```
if_case2: # name of the second conditional block
  condition: output1 has X and Z data
  instructions:
    - device1 run command line abc
    - device2 configure cfg_case2
    - wait for 10 seconds
    - device1 verify command line abc that status of component-1
is on
```

Line 4 is also a conditional block which has unmatched condition of case1 and case2 and it can be arranged as the following:

| | |
|---|---|
| if_other: | # name of the last conditional block |
| condition: null | # unmatched condition of case 1 and 2 |

instruction: device1 verify command line abc that status of
component-1 is on

After replacing placeholder_for_line_3 and placeholder_for_line4, the YAML layout should look like the one below:

| - assignment: | |
|---|---|
| output1: device1 run command line xyz | |
| - if_case1: | # name of the first conditional block |
| condition: output1 has X and Y data | |
| instructions: | |
| - device1 run command line abc | |
| - device1 configure cfg_case1 | |
| - wait for 5 seconds | |
| - device1 verify command line abc that status of | |
| component-1 is off | |
| - if_case2: | # name of the second conditional block |
| condition: output1 has X and Z data | |
| instructions: | |
| - device1 run command line abc | |
| - device2 configure cfg_case2 | |
| - wait for 10 seconds | |
| - device1 verify command line abc that status of | |
| component-1 is on | |
| - if_other: | # name of the last conditional block |
| condition: null | # unmatched condition of case 1 and 2 |

instruction: device1 verify command line abc that status of
component-1 is on
- instruction: device 1 run restoring configuration
- instruction: device 2 run restoring configuration

Assuming the name of this complex scenario is abc_scenario and it belongs to test_case_1, the YAML format of this case be described in config_file as:

```
testcases:
  test_case_1:
    abc_scenario:
      - assignment:
        output1: device1 run command line xyz
```

| | |
|---|---|
| - if_case1: | # name of the first conditional |

```
block
        condition: output1 has X and Y data
        instructions:
          - device1 run command line abc
          - device1 configure cfg_case1
          - wait for 5 seconds
          - device1 verify command line abc that status of
component-1 is off
```

| | |
|---|---|
| - if_case2: | # name of the second conditional |

```
block
        condition: output1 has X and Z data
        instructions:
          - device1 run command line abc
          - device2 configure cfg_case2
          - wait for 10 seconds
          - device1 verify command line abc that status of
Component-1 is on
```

| | |
|---|---|
| - if_other: | # name of the last conditional |

block

| | |
|---|---|
| condition: null | # unmatched condition of case 1 and |

```
2
        instruction: device1 verify command line abc that
status of component-1 is on
      - instruction: device 1 run restoring configuration
      - instruction: device 2 run restoring configuration
```

To generate test script from this scenario that will be equivalent to previous solution, user simply states:
generate from config_file.testcases.test_case_1.abc_scenario

This shows that describing complex documents can be improved by providing an alternative simplification method to reduce the complexity description for more clarification.

### Consistency Rule

The Describe-Get-System is a digital assistant tool that allows users to describe their test requirements in natural language with some logic to produce test script. During the describing process, users often expect some kind of consistencies such as visual consistency, functional consistency, internal consistency, and external consistency on the system for improving usability, reducing errors, and enhancing the perception of quality.

Visual consistency assists users to gain knowledge of the related communication between their document and describing work. Describing a problem or procedure often divides into three tasks: initiation, layout, and iterating describing subset of problem or an action of procedure. For example, user1 needs to describe the procedure below:

```
Tested devices: device1 and device2
Precondition:
  Make sure software version of both devices must be equal or newer
than the baseline version, i.e. 3.0.0.
  Make sure components 1 and 2 of device1 are operational and
online.
  Make sure components 1, 2, and 4 of device 2 are operational and
online.
  Note: Use “show version” to verify version and use “show device
info” to verify component.
Test Procedure:
  Bring down device1-component2, wait for 5 seconds, and make sure
device1-component2 and device2-component1 are not running and offline.
  Bring up device1-component2, wait for 30 seconds, and make sure
device1-component2 and device2-component1 are operational and online.
  Note: Use “show device info” to verify component.
Expected Result:
  Component and its peer component are not running when one
component is down.
  Component and its peer component are operational if both are
configured.
```

The initiation task should be a process of constructing the basic context that can establish connection and release connection or resource.
Tested devices: device1 and device2

As an example, the description may be:

```
SETUP
  CONNECT TEST RESOURCE (if needed)
  CONNECT DEVICE {device1, device2}
TEARDOWN
  DISCONNECT DEVICE {device1, device2}
  RELEASE DEVICE {device1, device2}
  RELEASE TEST RESOURCE (if needed)
```

The layout task should be a process of organizing or summarizing major actions or steps into sections.

```
Precondition:
Test Procedure:
  Bring down device1-component2, ...
  Bring up device1-component2, ...
```

As an example, the description might be

```
SETUP
  CONNECT TEST RESOURCE (if needed)
  CONNECT DEVICE {device1, device2}
SECTION: Precondition
  DUMMY_PASS - TODO: Need to describe all actions in
  precondition step
SECTION: Bring down component and verify
  DUMMY_PASS - TODO: Need to describe all actions in
  bring down step
SECTION: Bring up component and verify
  DUMMY_PASS - TODO: Need to describe all actions in
  bring up step
TEARDOWN
  DISCONNECT DEVICE {device1, device2}
  RELEASE DEVICE {device1, device2}
  RELEASE TEST RESOURCE (if needed)
```

Iterating describing subset of problem or an action of procedure should be a process of separating or slicing action and then iteratively describing it.

```
SETUP
  CONNECT TEST RESOURCE (if needed)
  CONNECT DEVICE {device1, device2}
SECTION: Precondition
  {device1, device2} EXECUTE show version USING_TEMPLATE
storage.template1 SELECT version WHERE version >= version(3.0.0) MUST
BE TRUE
  DUMMY_PASS - TODO: Need to describe operational verification for
device1
  DUMMY_PASS - TODO: Need to describe operational verification for
device2
SECTION: Bring down component and verify
  DUMMY_PASS - TODO: Need to describe all actions in bring down step
SECTION: Bring up component and verify
  DUMMY_PASS - TODO: Need to describe all actions in bring up step
TEARDOWN
  DISCONNECT DEVICE {device1, device2}
  RELEASE DEVICE {device1, device2}
  RELEASE TEST RESOURCE (if needed)
```

If for some reason, user1 cannot continue this work because of changing work priority, vacation, or sick leave, then the project manager can reassign the incomplete work to another user. After reviewing the test procedure with an incomplete describing solution, the new user can quickly engage and confidently finish this work because he or she can visually recognize the related communication between test procedure and describing solution. In summary, visual consistency design should be recommended to assist users to gain knowledge of the related communication between their document and describing work.

Functional consistency assists users to increase predictability results and creates a sense of security and safe use. For example, user needs to verify package status for the system.

Scenario 1: using command line “show packages info json-format” to verify package status. The output looks similar to the one below:

```
{
  “Packages”: {
    [
      {“name”: “pkg1”, “version”: “1.1.2”, “status”: “current”},
      {“name”: “pkg2”, “version”: “0.7.3”, “status”: “outdated”},
      {“name”: “pkg3”, “version”: “1.3.6”, “status”: “current”},
    ]
  }
}
```

In this case, the output is already constructed in proper data structure. The best practice to describe this case is that the application or method should provide functional choice to use its raw data for verification. User1 expects a describing statement should look like the below:

device1 EXECUTE show packages info json-format USING_JSON
SELECT name,
version, status WHERE status NOT_EQUAL outdated MUST BE FALSE

Scenario 2: using command line “show packages info csv-format” to verify package status. The output looks similar to the one below:

“name”,“version”,“status”
“pkg1”,“1.1.2”,“current”
“pkg2”,“0.7.3”,“outddated”
“pkg3”,“1.3.6”,“current”

For this case, user1 should describe something like the below:

device1 EXECUTE show packages info csv-format USING_CSV
SELECT name,
version, status WHERE status NOT_EQUAL outdated MUST BE FALSE

Scenario 3: using command line “show packages info” to verify package status. The output looks similar to the one below:

```
Packages:
  - pkg1 version 1.1.2 (current)
  - pkg2 version 0.7.3 (outdated)
  - pkg3 version 1.3.6 (current)
```

The output of this case is constructed for human readable text. It needs to transform to structure data for processing verification. Assuming TextFSM is a primary choice for transforming human readable text to structure data, then user1 needs to build the TextFSM template and store template in storage as template1:

######################################################################
##########
# Template is generated by templateapp Community Edition

| # Created by | : user1 |
|---|---|
| # Email | : user1@abc_xyz.com |
| # Company | : ABC XYZ Inc. |
| # Created date | : 2022-04-05 |

######################################################################
##########
Value name ([a-zA-Z0-9]+)
Value version ([0-9]\S*)
Value status ([a-zA-Z0-9]+)
Start
\hat{ } +− ${name} version ${version} \(${status}\) *$$ −> Record

User1 could describe this case as:

device1 EXECUTE show packages info USING_TEMPLATE
storage.template1
SELECT name, version, status WHERE status NOT_EQUAL
outdated MUST BE
FALSE

When data is already constructed in structure format, the method or application should provide the function to directly use that data. If structure data cannot apply in the method or application for verification, it should clearly notify user about its limitation. It is an uncommon practice to use alternative solutions to transform structure data to another format when it implicitly contains solution for verification. In summary, functional consistency design should be recommended to increase the predictability of the results and create a sense of security and safe use.

Internal consistency assists users to improve usability within the application. For example, user1 needs to verify the software version of system that it must be greater than or equal to baseline version 1.0.0. In this test, installed software of these devices are from a stable release. Assuming there is an available template to parse the above output and it is stored in template storage as template1, user1 could describe a statement like below:

device1 EXECUTE show version USING_TEMPLATE
storage.template1 SELECT
version WHERE version EQUAL_OR_GREATER_THAN
semantic_version(1.0.0)
MUST BE TRUE

In summary, the internal consistency design should be recommended to assist users improve usability within the application.

External consistency assists users to produce the product to function or work the same across multiple systems. For code generator, external consistency design must fully apply. In addition, the method or application should be fully supported or recommended external consistency use-case for test maintenance, test execution, and or reporting service to a third-party if necessary. Finally, the method or application will let users determine or announce the external consistency of their connector.

### Verification

Productivity Test Automation System requires that every verification of test data needs to transform to a searchable table row-column data structure. As a result, the user needs to select the correct field to match his or her expectations. There are two types of requirements: specific requirements and generic requirements. Furthermore, there are also two types of expectations: implicit expectation and explicit expectation. Assuming after parsing device output, the result is:

| | | | | | |
|---|---|---|---|---|---|
| + | ------------- | +------------- | +-------------- | +--------- | + |
| \| | name | \|status | \|connectivity | \|reboot | \| |
| + | ------------- | +------------- | +-------------- | +--------- | + |
| \| | component-1 | \|operational | \|online | \|0 | \| |
| \| | component-2 | \|operational | \|online | \|1 | \| |
| \| | component-3 | \|not running | \|offline | \|0 | \| |
| \| | component-4 | \|error | \|N/A | \|unknown | \| |
| \| | component-5 | \|operational | \|online | \|0 | \| |
| \| | component-6 | \|operational | \|online | \|0 | \| |
| + | ------------- | +------------- | +-------------- | +--------- | + |

### Example 1: Providing a Verification Statement

In this example, a verification statement is provided to prove that component-3 is not running and its connectivity is offline. In this case, there are three values that need to confirm “component-3”, “not running”, and “offline”. Because the user knows his or her test data well, the user can bind “name”, “status”, and “connectivity” columns to requirements. Based on user knowledge and provided requirements, the verification requirement of this example is a specific requirement. User might come up with this verification statement:

SELECT name, status, connectivity WHERE name
EQUAL_TO component-
3 AND status EQUAL_TO “not running” AND
connectivity EQUAL_TO
offline

The user knows that the name of component is unique. Based on user common sense, the user expects the return result is one or True. The expectation of this case becomes implicit expectation. To make the verification explicitly, it should be:

SELECT name, status, connectivity WHERE name EQUAL_TO component-
3 AND status EQUAL_TO ″not running″ AND connectivity EQUAL_TO
offline MUST BE EQUAL_TO 1
Or
SELECT name, status, connectivity WHERE name EQUAL_TO component-
3 AND status EQUAL_TO ″not running″ AND connectivity EQUAL_TO
offline MUST BE True
Note: “MUST BE True” is equivalent to “MUST BE EQUAL_TO 1” or
“MUST BE False” is equivalent to “MUST BE EQUAL_TO 0”.

### Example 2: Providing Another Verification Statement

In this example, the verification statement is provided to prove that component-1 and component-2 are operational and their connectivity are online.

SELECT name, status, connectivity WHERE name EQUAL_TO component-
1 OR name EQUAL_TO component-2 AND status EQUAL_TO operational
AND connectivity EQUAL_TO online
The specific requirement and explicit expectation for this example is
SELECT name, status, connectivity WHERE name EQUAL_TO component-
1 OR name EQUAL_TO component-2 AND status EQUAL_TO operational
AND connectivity EQUAL_TO online MUST BE EQUAL_TO 2

### Example 3: Providing Another Verification Statement

In this example, the verification statement is provided to prove that the system is healthy and all working components are not offline or N/A (Note: component 3 and 4 are service components and they must be excluded for verification). In this case, “the system is healthy” has no relevant information relating to output and it can be considered as a generic requirement. Depending on user's decision, the user might relate the equivalent requirements and expectation to “all working component are not offline or N/A” which has some relevant data to output. Furthermore, “all working components” is a vague expectation. The user needs to provide an approximate or exact quantity for verification. This example assumes the user considers the following requirements: (1) at least four working components are not offline or N/A; and (2) component-3 and component-4 must be skipped.

The verification statement for this case that satisfies specific requirements and explicit expectation is

SELECT name, connectivity EXCLUDE name BELONG (component-3,
component-4) WHERE connectivity NOT_EQUAL offline OR
connectivity NOT_EQUAL N/A MUST BE AT_LEAST 4

### Example 4: Providing Another Verification Statement

In this example, the verification statement is provided to prove that the system is healthy (Note: component 3 and 4 are service components and they must be excluded for verification.)

In this case, the verification statement cannot be created because its requirements and expectations are very generic. The requirements and expectations for this case need to be clarified for verification. As a result, the specific requirements and explicit expectation must apply to the verification statement to get the correct output.

### The Productivity Test Automation System Language

Productivity Test Automation System language has several types of statements: data connection statement, section statement, pausing statement, iteration statement, performer statement, and verification statement.

Data Connection Statement:

CONNECT DATA <filename or database> AS <test_resource>
USE TESTCASE <testcase_name> AS <test_data>
CONNECT DEVICE <device1> AS <device1_alias>, ?<device2> AS
<device2_alias>?, ?<device3>
AS <device3_alias>?
DISCONNECT DEVICE <device1_alias>, <device2_alias>, ...
RELEASE <filename or database>

Section Statement:

SETUP
TEARDOWN
SECTION: <description>

Pausing Statement:
WAIT FOR <duration in second>

Iteration Statement:

```
LOOP <iteration_count> TIMES
  <Performer Statement(s)>
  <Verification Statement(s)>
  <Pausing Statement(s)>
```

Note: LOOP statement would stop and raise exception when one of verification statement is FAILED.

```
LOOP <iteration_count> TIMES UNTIL
  <Performer Statement(s)>
  <Verification Statement(s)>
  <Pausing Statement(s)>
```

Note: LOOP UNTIL statement would stop early when all of verification statements are PASSED. It would raise an exception if none of verification is PASSED.

```
LOOP <iteration_count> TIMES TO LAST
  <Performer Statement(s)>
  <Verification Statement(s)>
  <Pausing Statement(s)>
```

Note: LOOP TO LAST statement would continue to iterate to the last iteration and raise an exception if any verification statement of last iteration is FAILED.

### Performer Statement:

<device_alias> EXECUTE <cmdline> TEMPLATE_SYNTAX
SELECT_STATEMENT_SYNTAX AS
<result>

Note: TEMPLATE_SYNTAX, SELECT_STATEMENT and AS are optional.

Verification Statement:

<device_alias> EXECUTE <cmdline> TEMPLATE_SYNTAX
SELECT_STATEMENT_SYNTAX
UNTIL_SYNTAX MUST BE <true/false>
<device_alias> EXECUTE <cmdline> TEMPLATE_SYNTAX
SELECT_STATEMENT_SYNTAX
UNTIL_SYNTAX MUST BE VERIFICATION_OPERATOR <integer>

Note: MUST BE true is equivalent to MUST EQUAL_TO 1 and MUST BE false is equivalent to MUST BE EQUAL_TO 0 or vice versa.

### TEMPLATE_SYNTAX:

USING TEMPLATE <template_id>
USING TEMPLATE <template_id>HORIZONTAL MERGE WITH <other_template_id>
USING TEMPLATE <template_id>HORIZONTAL MERGE WITH <other_template_id>BY <column_A_from_current_template, column_B_from_other_template>
USING TEMPLATE <template_id>HORIZONTAL MERGE WITH <other_result>
USING TEMPLATE <template_id>HORIZONTAL MERGE WITH <result>BY <column_A_from_current_template, column_B_from_other_result>
USING TEMPLATE <template_id>VERTICAL MERGE WITH <other_template_id>
USING TEMPLATE <template_id>VERTICAL MERGE WITH <other_result>

Note: merging between templates should happen on the same output. Merging between template and other result can happen on the same or different output.

### SELECT_STATEMENT_SYNTAX:

SELECT <column, column>WHERE <predicate>AND | OR<predicate>
SELECT <column, column>EXCLUDE <predicate>AND | OR<predicate>WHERE <predicate>AND|OR<predicate>

Predicate format: <left>PREDICATE_OPERATOR <right><left>operand is a column name or header of row-column table data structure. <right>operand is
an expected value.
If<left>operand needs to perform version comparison, then encapsulate version or semantic_version with an expected value, e.g., version(1.1.0.a), semantic_version(1.1.0)
If<left> operand needs to perform datetime comparison, then encapsulate datetime with an expected value, e.g., datetimeJul. 10, 2021 08:56:45, format-format1), or datetime(Friday, Apr. 9, 2021 8:43:15 PM, format=format3).

PREDICATE_OPERATOR can be
EQUAL_TO, EQ
NOT_EQUAL, NE
GREATER_THAN, GT
GREATER_THAN_OR_EQUAL, GT
LESS_THAN, LT
LESS_THAN_OR_EQUAL, LE
BELONG, NOT_BELONG
IN, NOT_IN
MATCH, NOT_MATCH
IS, IS_NOT

UNTIL SYNTAX:
UNTIL <ntimes>/<interval>

Ntimes must be a whole number or empty. Empty ntimes is equivalent to one execution. The interval must be a positive number.

VERIFICATION_OPERATOR can be
EQUAL_TO, EQ
NOT_EQUAL, NE
GREATER_THAN, GT
GREATER_THAN_OR_EQUAL, GE
LESS_THAN, LT
LESS_THAN_OR_EQUAL, LE

### Porting Test Procedure To Productivity Test Automation System Language

In porting test procedure to Productivity Test Automation System language, every test must begin with SETUP and end with a TEARDOWN section. The test can have one or multiple sections. The description below assumes a device connectivity test case.

```
Tested devices: device1 and device2
Precondition :
  Make sure software version of both devices must be equal or
newer than the baseline version, i.e. 3.0.0.
  Make sure components 1 and 2 of devicel are operational and
online.
  Make sure components 1, 2, and 4 of device 2 are operational
and online.
  Note: Use “show version” to verify version and use “show
device info” to verify component.
Test Procedure:
  Bring down device1-component2, wait for 5 seconds, and make
sure device1-component2 and device2-component1 are not running
and offline.
  Bring up device1-component2, wait for 30 seconds, and make
sure device1-component2 and device2-component1 are operational
and online.
  Note: Use “show device info” to verify component.
Expected Result:
  Component and its peer component are not running when one
component is down.
  Component and its peer component are operational if both are
configured.
```

In this example it is assumed that the “show version” output has template with id as parsed_show_version_tmp1, and “show device info” output has template with id as parsed_show_device_info_tmp1. It is also assumed that the test case name is tc_3 and bring_down_cfg and bring_up_cfg configurations are stored in test resource.

In this example, porting a snippet to the Productivity Test Automation System will look similar to the one below:

```
SETUP:
  CONNECT DATA data file.yaml AS test resource
  USE TESTCASE tc 3 AS test data
  CONNECT DEVICE device1 AS device1, device2 AS device2
SECTION: Precondition
  device1 EXECUTE show version USING TEMPLATE
parsed show version tmpl SELECT version WHERE version
GREATER THAN OR EQUAL version (3.0.0) MUST BE true
  device2 EXECUTE show version USING TEMPLATE
parsed show version tmpl SELECT version WHERE version
GREATER THAN OR EQUAL version (3.0.0) MUST BE true
  device1 EXECUTE show device info USING TEMPLATE
parsed_show_device_info_tmpl SELECT name, status, connectivity
WHERE name BELONG (component1, component2) AND status EQUAL_TO
operational AND connectivity EQUAL_TO online MUST BE EQUAL_TO 2
  device2 EXECUTE show device info USING TEMPLATE
parsed_show_device_info_tmpl SELECT name, status, connectivity
WHERE name BELONG (component1, component2, component4) AND
status EQUAL_TO operational AND connectivity EQUAL_TO online
MUST BE EQUAL_TO 3
SECTION: Bring one component of devicel down and verify its peer
component is down
  device1 CONFIGURE test_resource.bring_down_cfg
  WAIT FOR 5 seconds
  device1 EXECUTE show device info USING_TEMPLATE
parsed_show_device_info_tmpl SELECT name, status, connectivity
WHERE name EQUAL_TO component2 AND status EQUAL_TO “not running”
AND connectivity EQUAL_TO offline MUST BE true
  device2 EXECUTE show device info USING TEMPLATE
parsed_show_device_info_tmpl SELECT name, status, connectivity
WHERE name EQUAL_TO component1 AND status EQUAL_TO “not running”
AND connectivity EQUAL_TO offline MUST BE true
SECTION: Bring one component of devicel up and verify its peer
component is up
  device1 CONFIGURE test_resource.bring_up_cfg
  WAIT FOR 30 seconds
  device1 EXECUTE show device info USING_TEMPLATE
parsed_show_device_info_tmpl SELECT name, status, connectivity
WHERE name EQUAL_TO component2 AND status EQUAL_TO operational
AND connectivity EQUAL_TO online MUST BE true
  device2 EXECUTE show device info USING TEMPLATE
parsed_show_device_info_tmpl SELECT name, status, connectivity
WHERE name EQUAL_TO component1 AND status EQUAL_TO operational
AND connectivity EQUAL_TO online MUST BE true
TEARDOWN :
  DISCONNECT DEVICE device1, device2
  RELEASE test_resource
```

### Part D: Building Test Script

In certain embodiments, the Productivity Test Automation System Application provides three options to build test script. They are Unittest, PyTest, and Robotframework. In the following description, it is assumed that there are some referring names for class and methods from test resources.

```
testcases:
  tc_3:
    script_builder:
      class_name: DeviceConnectivityTC
      test_precondition: precondition
      test_bring_down_and_verify_peer_component_down: |-
        Bring one component of devicel down and verify component
and its peer component are down
      test_bring_up_and_verify_peer_component_up: |-
        Bring one component of devicel up and verify component
and its peer component are up
```

The generated Unittest script will look similar to the one below:

```
import unittest
import productivitytestautomationsystem as ta
class DeviceConnectivityTC(unittest.TestCase):
  def setUp(self):
    self.test_resource =
ta.connect_data(filename=‘test_resource_filename.yaml’)
    self.test_data = ta.use_testcase(self.test_resource,
testcase=‘tc_3’)
    self.device1 = ta.connect_device(self.test_resource,
name=‘device1’)
    self.device2 = ta.connect_device(self.test_resource,
name=‘device2’)
  def tearDown(self):
    ta.disconnect_device(self.device1)
    ta.disconnect_device(self.device2)
    ta.release(self.test_resource)
  def test_precondition(self):
    output = ta.execute(self.device1, cmdline=‘show
version’)
    result = ta.verify(
      template=‘parsed_show_version_tmpl’,
      data=output,
      select_statement=‘SELECT version WHERE version
GREATER_THAN_OR_EQUAL version(3.0.0)’
    )
    total_count = len(result)
    self.assertTrue(total_count == 1)
    output = ta.execute(self.device2, cmdline=‘show
version’)
    result = ta.verify(
      template=‘parsed_show_version_tmpl’,
      data=output,
      select_statement=‘SELECT version WHERE version
GREATER_THAN_OR_EQUAL version (3.0.0)’
    )
    total_count = len(result)
    self.assertTrue(total_count == 1)
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name BELONG (component1, component2) AND status EQUAL_TO
operational AND connectivity EQUAL_TO online’
    )
    total_count = len(result)
    self.assertTrue(total_count == 2)
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name BELONG (component1, component2, component4) AND
status EQUAL_TO operational AND connectivity EQUAL_TO online’
    )
    total_count = len(result)
    self.assertTrue(total_count == 3)
  def test_bring_down_and_verify_peer_component_down(self):
    cfg_lines = self.test_data.get(‘bring_down_cfg’)
    ta.configure(self.device1, cfg=cfg_lines)
    ta.wait_for(5)
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name EQUAL_TO component2 AND status EQUAL_TO “not running”
AND connectivity EQUAL_TO offline’
    )
    total_count = len(result)
    self.assertTrue(total_count == 1)
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name EQUAL_TO component1 AND status EQUAL_TO “not running”
AND connectivity EQUAL_TO offline’
    )
    total_count = len(result)
    self.assertTrue (total count == 1)
  def test_bring_up_and_verify_peer_component_up(self):
    cfg_lines = self.test_data.get(‘bring_up_cfg’)
    ta.configure(self.device1, cfg=cfg_lines)
    ta.wait_for(30)
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name EQUAL_TO component2 AND status EQUAL_TO operational
AND connectivity EQUAL_TO online’
    )
    total_count = len(result)
    self.assertTrue(total count == 1)
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name EQUAL_TO component1 AND status EQUAL_TO operational
AND connectivity EQUAL_TO online’
    )
    total_count = len(result)
    self.assertTrue(total_count == 1)
```

The generated PyTest script will look similar to the one below:

```
import productivitytestautomationsystem as ta
class DeviceConnectivityTC:
  def setup_class(self):
    self.test_resource =
ta.connect_data(filename=‘test_resource_filename.yaml’)
    self.test_data = ta.use_testcase(self.test_resource,
testcase=‘tc_3’)
    self.device1 = ta.connect_device(self.test_resource,
name=‘devicel’)
    self.device2 = ta.connect_device(self.test_resource,
name=‘device2’)
  def teardown_class(self):
    ta.disconnect_device(self.device1)
    ta.disconnect_device(self.device2)
    ta.release(self.test_resource)
  def test_precondition(self):
    output = ta.execute(self.device1, cmdline=‘show
version’)
    result = ta.verify(
      template=‘parsed_show_version_tmpl’,
      data=output,
      select statement=‘SELECT version WHERE version
GREATER_THAN_OR_EQUAL version(3.0.0)’
    )
    total_count = len(result)
    assert total_count == 1
    output = ta.execute(self.device2, cmdline=‘show
version’)
    result = ta.verify(
      template=‘parsed_show_version_tmpl’,
      data=output,
      select_statement=‘SELECT version WHERE version
GREATER_THAN_OR_EQUAL version(3.0.0)’
    )
    total_count = len(result)
    assert total_count == 1
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name BELONG (component1, component2) AND status EQUAL_TO
operational AND connectivity EQUAL_TO online’
    )
    total_count = len(result)
    assert total_count == 2
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name BELONG (component1, component2, component4) AND
status EQUAL_TO operational AND connectivity EQUAL_TO online’
    )
    total_count = len(result)
    assert total_count == 3
  def test_bring_down_and_verify_peer_component_down(self):
    cfg_lines = self.test_data.get(‘bring_down_cfg’)
    ta.configure(self.device1, cfg=cfg_lines)
    ta.wait_for(5)
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name EQUAL_TO component2 AND status EQUAL_TO “not running”
AND connectivity EQUAL_TO offline’
    )
    total count = len(result)
    assert total_count == 1
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name EQUAL_TO component1 AND status EQUAL_TO “not running”
AND connectivity EQUAL_TO offline’
    )
    total_count = len(result)
    assert total_count == 1
  def test_bring_up_and_verify_peer_component_up(self):
    cfg_lines = self.test_data.get(‘bring_up_cfg’)
    ta.configure(self.device1, cfg=cfg_lines)
    ta.wait_for(30)
    output = ta.execute(self.device1, cmdline=‘show device
info’)
    result = ta.verify(
      template=‘parsed_show_device_info_tmpl’,
      data=output,
      select_statement=‘SELECT name, status, connectivity
WHERE name EQUAL_TO component2 AND status EQUAL_TO operational
AND connectivity EQUAL_TO online’
    )
    total_count = len(result)
    assert total_count == 1
    output = ta.execute(self.device2, cmdline=‘show device
info’)
    result = ta.verify(
      template=‘parsed_show_device_info_tmpl’,
      data=output,
      select_statement=‘SELECT name, status, connectivity
WHERE name EQUAL_TO component1 AND status EQUAL_TO operational
AND connectivity EQUAL_TO online’
    )
    total_count = len(result)
    assert total_count == 1
```

The generated Robotframework test script will look similar to the one below:

*** Settings ***

| | |
|---|---|
| Library | BuiltIn |
| Library | Collections |
| Library | productivitytestautomationsystem |
| Test Setup | setup |
| Test Teardown | teardown |

```
*** Test Cases ***
DeviceConnectivityTC
  test_precondition
  test_bring_down_and_verify_peer_component_down
  test_bring_up_and_verify_peer_component_up
*** Keywords ***
setup
  ${test resource} = connect data
test resource filename.yaml
  set global variable ${test resource}
  ${test data}= use testcase ${test resource}
testcase=tc 3
  set global variable ${test data}
  ${device1} = connect device ${test resource}
name=device1
  set global variable ${device1}
  ${device2} = connect device ${test resource}
name=device1
  set global variable ${device2}
teardown
  disconnect device ${device1}
  disconnect device ${device2}
  release ${test resource}
test precondition
  ${output} = execute ${device1} cmdline=show version
  ${result} = verify template=parsed show version tmpl
  ... select statement=SELECT version WHERE version
GREATER THAN OR EQUAL version (3.0.0)
  ${total count}= get length ${result}
  should be true ${result} == 1
  ${output} = execute ${device2} cmdline=show version
  ${result} = verify template=parsed show version tmpl
  ... data=${output}
  ... select statement=SELECT version WHERE version
GREATER THAN OR EQUAL version (3.0.0)
  ${total count}= get length ${result}
  should be true ${result} == 1
  ${output} = execute ${device1} cmdline=show device info
  ${result}= verify template=parsed_show_device_info_tmpl
  ... data=${output}
  ... select statement=SELECT name, status, connectivity
WHERE name BELONG (component1, component2) AND status EQUAL_TO
operational AND connectivity EQUAL_TO online
  ${total count}= get length ${result}
  should be true ${result} == 2
  ${output} = execute ${device2} cmdline=show device info
  ${result} = verify template=parsed_show_device_info_tmpl
  ... data=${output}
  ... select statement=SELECT name, status, connectivity
WHERE name BELONG (component1, component2, component4) AND
status EQUAL_TO operational AND connectivity EQUAL_TO online
  ${total count}= get length ${result}
  should be true ${result} == 3
test bring down and verify peer component down
  ${cfg lines}= get from dictionary ${test data}
bring down cfg
  configure ${device1} cfg=${cfg lines}
  wait for 5
  ${output} = execute ${device1} cmdline=show device info
  ${result}= verify template=parsed_show_device_info_tmpl
  ... data=${output}
  ... select statement=SELECT name, status, connectivity
WHERE name EQUAL_TO component2 AND status EQUAL_TO “not running”
AND connectivity EQUAL_TO offline
  ${total count}= get length ${result}
  should be true ${result} == 1
  ${output} = execute ${device2} cmdline=show device info
  ${result}= verify template=parsed_show_device_info_tmpl
  ... data=${output}
  ... select statement=SELECT name, status, connectivity
WHERE name EQUAL_TO component1 AND status EQUAL_TO “not running”
AND connectivity EQUAL_TO offline
  ${total count} = get length ${result}
  should be true ${result} == 1
test bring up_and_verify peer_component_up
  ${cfg lines}= get from dictionary ${test data}
bring up cfg
  configure ${device1} cfg=${cfg lines}
  wait for 30
  ${output} = execute ${device1} cmdline=show device info
  ${result}= verify template=parsed_show_device_info_tmpl
  ... data=${output}
  ... select statement=SELECT name, status, connectivity
WHERE name EQUAL_TO component2 AND status EQUAL_TO operational
AND connectivity EQUAL_TO online
  ${total count}= get length ${result}
  should be true ${result} == 1
  ${output} = execute ${device2} cmdline=show device info
  ${result} = verify template=parsed_show_device_info_tmpl
  ... data=${output}
  ... select statement=SELECT name, status, connectivity
WHERE name EQUAL_TO component1 AND status EQUAL_TO operational
AND connectivity EQUAL_TO online
  ${total count}= get length ${result}
  should be true ${result} == 1
```

### Describe-Get-System-Proof-Of-Concept

### Proof of Concept

### Preparation Steps

Step 1: Installing Vagrant and Virtualbox software.
Vagrant installation: https://www.vagrantup.com/docs/installation
Virtualbox installation:
https://www.virtualbox.org/manual/UserManual.html #installation windows

Step 2: Creating Vagrantfile

Manually creating and editing Vagrantfile:

```
Vagrant.configure (‘2’) do |config|
  config.vm.box = ‘hashicorp/bionic64’
  config.vm.hostname = ‘demo-machine’
  config.vm.define ‘describe-get-system-demo-vm’
  config.vm.provider :virtualbox do |vb|
    vb.name = ‘describe-get-system-demo-vm’
  end
  config.vm.provision ‘shell’, inline: <<-SHELL
    apt-get update
    apt-get install --yes python3-venv
    python3 -m venv virtual python
    source virtual_python/bin/activate 2>/dev/null
    pip install dgspoc gtunrealdevice 2>/dev/null
    echo source virtual_python/bin/activate >> .profile
  SHELL
End
```

Creating Vagrantfile using command line for Linux or MacOS users:

echo -e “Vagrant.configure (‘2’) do |config|\n config.vm.box =
‘hashicorp/bionic64’\n config.vm.hostname = ‘demo-machine’\n
config.vm.define ‘describe-get-system-demo-vm’\n
config.vm.provider :virtualbox do |vb|\n vb.name = ‘describe-
get-system-demo-vm’\n end\n config.vm.provision ‘shell’,
inline: <<-SHELL\n apt-get update\n apt-get install --yes
python3-venv\n python3 -m venv virtual_python\n source
virtual_python/bin/activate 2>/dev/null\n pip install dgspoc
gtunrealdevice 2>/dev/null\n echo source
virtual_python/bin/activate >> .profile\n SHELL\nend” >
Vagrantfile

Creating Vagrantfile using command line for Windows users:

powershell write-host ″Vagrant.configure‘(‘′2‘′‘) do
‘|config‘|‘n‘ ‘ config.vm.box = ‘′hashicorp/bionic64‘′‘n‘ ‘
config.vm.hostname = ‘′demo-machine‘′‘n‘ ‘ config.vm.define
‘'describe-get-system-demo-vm‘′‘n‘ ‘ config.vm.provider
:virtualbox do ‘|vb‘|‘n‘ ‘ ‘ ‘ vb.name = ‘′describe-get-system-
demo-vm‘'‘n‘ ‘ end‘n‘ ‘ config.vm.provision ‘′shell‘′‘, inline:
‘<‘<-SHELL‘n‘ ‘ ‘ ‘ apt-get update ‘n‘ ‘ ‘ ‘ apt-get install --
yes python3-venv‘n‘ ‘ ‘ ‘ python3 -m venv virtual_python ‘n‘ ‘ ‘
‘ source virtual_python/bin/activate 2‘>/dev/null‘n‘ ‘ ‘ ‘ pip
install dgspoc gtunrealdevice 2‘>/dev/null ‘n‘ ‘ ‘ ‘ echo ″source
virtual_python/bin/activate″ ‘>‘> .profile‘n‘ ‘ SHELL‘nend″ >
Vagrantfile

Step 3: Executing the following command lines.

Note: Windows users should execute the command lines below on DOS Command Prompt console terminal:

vagrant up describe-get-system-demo-vm
vagrant ssh
pip freeze | egrep −i
“dgspoc|dlapp|gtunrealdevice|pytest|dateutil|pyyaml|regexapp|rob
otframework|templateapp|textfsm|unittest”

Expecting to see the below output of the last command line that must have dgspoc, dlapp, gtunrealdevice, pytest, python-dateutil, pytest, regexapp, robotframework, templateapp, textfsm, and unittest-xml-reporting packages:

virtual_python) vagrant@demo-machine:~$ pip freeze | egrep −i
“dgspoc|dlapp|gtunrealdevice|pytest|dateutil|pyyaml|regexapp|rob
otframework|templateapp|textfsm|unittest”
dgspoc==0.3.10.1
dlapp==0.3.6
gtunrealdevice==0.2.8
pytest==7.0.1
python-dateutil==2.8.2
PyYAML==6.0
regexapp==0.3.8
robotframework==5.0.1
templateapp==0.1.9
textfsm==1.1.2
unittest-xml-reporting==3.1.0
(virtual_python) vagrant@demo-machine:~$

Step 4: Cleanup after completed work.
Removing demo virtual machine by executing this command line: “vagrant destroy describe-get-system-demo-vm”
Deleting Vagrantfile
Uninstalling Vagrant and VirtualBox software

### Describe Process

Assuming the test procedure is:

```
Device: using unreal-device with host address 1.1.1.1
Test Procedure:
  Precondition: execute command line “show version”
  Verification 1: using “show modules” command line to verify
  that there are 4 running modules
```

### Describing Steps:

Step 1: General layout of describing snippet.

The first draft of describing snippet should be:

```
setup
  dummy_pass: establish connection for device 1.1.1.1
section: precondition
  dummy_pass: do something for precondition
section: verify that there are 4 running modules
  dummy_pass: do something for verification 1
teardown
  dummy_pass: release connection of device 1.1.1.1
```

Step 2: Describing setup and teardown.

The second draft should be:

```
setup
  connect device 1.1.1.1
section: precondition
  dummy_pass: do something for precondition
section: verify that there are 4 running modules
  dummy_pass: do something for verification 1
teardown
  release device 1.1.1.1
```

Step 3: Describing sections.

Step 3.1: Describing precondition section.

The precondition section only requires to execute command line “show version”. The third draft should be:

```
setup
  connect device 1.1.1.1
section: precondition
  1.1.1.1 execute show version
section: verify that there are 4 running modules
  dummy pass: do something for verification 1
teardown
  release device 1.1.1.1
```

Step 3.2: Describing verification 1 section.

Command line: show modules

Expectation: there are 4 running modules

Step 3.2.1: Revealing or showing output of show modules.

From describe-get-system-demo-vm, execute command line: dgs test-adaptor-unreal-device-action=“1.1.1.1 execute show modules”:

(virtual_python) vagrant@demo-machine:~$ dgs test --
adaptor=unreal-device --action=“1.1.1.1 execute show modules”
2022-05-27 21:58:07.046113 -
/home/vagrant/.geekstrident/gtunrealdevice/devices_info.yaml file
is created.
login unreal-device 1.1.1.1@dummy_username:dummy_password
May 27 2022 21:58:08.383 for “device32” - UNREAL-DEVICE-
AUTHENTICATION-SERVICE-TIMESTAMP
device32 is successfully connected.
2022-05-27 21:58:08.383439 -
/home/vagrant/.geekstrident/gtunrealdevice/serialized_data.yaml
file is created.
show modules
May 27 2022 21:58:09.808 for “device32” - UNREAL-DEVICE-
EXECUTION-SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

logout unreal-device 1.1.1.1
May 27 2022 21:58:11.204 for “device32” - UNREAL-DEVICE-
AUTHENTICATION-SERVICE-TIMESTAMP
device32 is disconnected.
UnrealDeviceMessage: +++ Successfully released 1.1.1.1 unreal-
device.
(virtual_python) vagrant@demo-machine:~$

The output of show modules is:

show modules
May 27 2022 21:58:09.808 for “device32” - UNREAL-DEVICE-
EXECUTION-SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

This output is unstructured text. It needs a parsed template.

Step 3.2.2: Looking for an available template for show modules.

Assuming the convention naming identification for template is device_os.(device_family.(device_module.)?)?cmdline. Assuming a template_id of this case is unrealos.show_modules. The search result might be:

virtual_python) vagrant@demo-machine:~$ dgs search template
unrealos.show_modules
+----------------------------------------------------------------
--------------+
| *** CANT find template ID because template storage file is not
created.
+----------------------------------------------------------------
--------------+
virtual_python) vagrant@demo-machine:~$

Since, unrealos.show_modules is not available yet, it needs to be built.

Step 3.2.3: Building template for show modules.

The output of “show modules” is organized as 5 columns: module, name, model, version, and status.

Step 3.2.3.1: building first template snippet and test.

Let's call the working template id is user1_working_template:

(virtual_python) vagrant@demo-machine:~$ dgs build template
“digits(var_module) −> record”
################################################################
###############
# Template is generated by templateapp Community Edition
# Created date: 2022-05-27
################################################################
###############
Value module (\d+)
Start
\hat{ }${module} −> Record
(virtual_python) vagrant@demo-machine:~$ dgs build template
“digits(var_module) −> record” --template-
id=user1_working_template --replaced
+----------------------------------------------------------------
--------------+
| +++ Successfully uploaded generated template to
“user1_working_template” |
| template ID.
|
+----------------------------------------------------------------
--------------+
(virtual_python) vagrant@demo-machine:~$
(virtual_python) vagrant@demo-machine:~$ dgs test --
adaptor=unreal-device --action=“1.1.1.1 execute show modules
using-template user1_working_template --tabular”
login unreal-device 1.1.1.1@dummy_username:dummy_password
May 27 2022 22:35:48.713 for “device294” - UNREAL-DEVICE-
AUTHENTICATION-SERVICE-TIMESTAMP
device294 is successfully connected.
show modules
May 27 2022 22:35:50.290 for “device294” - UNREAL-DEVICE-
EXECUTION-SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

logout unreal-device 1.1.1.1
May 27 2022 22:35:52.118 for “device294” - UNREAL-DEVICE-
AUTHENTICATION-SERVICE-TIMESTAMP
device294 is disconnected.
UnrealDeviceMessage: +++ Successfully released 1.1.1.1 unreal-
device.
+----------------------------------------------------------------
--------------+
| Parsed Results:
|
+----------------------------------------------------------------
--------------+

| | |
|---|---|
| +-------- | + |
| \| module | \| |
| \| 1 | + |
| \| 2 | \| |
| \| 3 | \| |
| \| 4 | \| |
| \| 5 | \| |
| +-------- | + |

(virtual_python) vagrant@demo-machine:~$

Step 3.2.3.2: building second template snippet and test.

The result is:

(virtual_python) vagrant@demo-machine:~$ dgs build template
“digits(var_module) words(var_name) mixed_word(var_model)
version(var_version) word(var_status) end(space) −> record”
################################################################
###############
# Template is generated by templateapp Community Edition
# Created date: 2022-05-27
################################################################
###############
Value module (\d+)
Value name ([a-zA-Z0-9]+( [a-zA-Z0-9]+)*)
Value model (\S*[a-zA-Z0-9]\S*)
Value version ([0-9]\S*)
Value status ([a-zA-Z0-9]+)
Start
\hat{ }${module} +${name} +${model} +${version} +${status} *$$ −>
Record
(virtual_python) vagrant@demo-machine:~$
(virtual_python) vagrant@demo-machine:~$
(virtual_python) vagrant@demo-machine:~$ dgs build template
“digits(var_module) words(var_name) mixed_word(var_model)
version(var_version) word(var_status) end(space) −> record” --
template-id=user1_working_template --replaced
+----------------------------------------------------------------
--------------+
| +++ Successfully uploaded generated template to
“user1_working_template” |
| template ID.
|
+----------------------------------------------------------------
--------------+
(virtual_python) vagrant@demo-machine:~$
(virtual_python) vagrant@demo-machine:~$ dgs test --
adaptor=unreal-device --action=“1.1.1.1 execute show modules
using-template user1_working_template --tabular”
login unreal-device 1.1.1.1@dummy_username:dummy_password
May 27 2022 22:47:39.874 for “device6” - UNREAL-DEVICE-
AUTHENTICATION-SERVICE-TIMESTAMP
device6 is successfully connected.
show modules
May 27 2022 22:47:40.451 for “device6” - UNREAL-DEVICE-EXECUTION-
SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

logout unreal-device 1.1.1.1
May 27 2022 22:47:42.213 for “device6” - UNREAL-DEVICE-
AUTHENTICATION-SERVICE-TIMESTAMP
device6 is disconnected.
UnrealDeviceMessage: +++ Successfully released 1.1.1.1 unreal-
device.
+----------------------------------------------------------------
--------------+
| Parsed Results:
|
+----------------------------------------------------------------
--------------+

| | | | | | |
|---|---|---|---|---|---|
| +-------- | +------------ | +-------- | +--------- | +--------- | + |
| \| module | \| name | \| model | \| version | \| status | \| |
| +-------- | +------------ | +-------- | +--------- | +--------- | + |
| \| 1 | \| Left Fan | \| FAN.1A | \| 1.1.0 | \| Running | \| |
| \| 2 | \| Right Fan | \| FAN.2C | \| 1.3.7 | \| Running | \| |
| \| 3 | \| Misc Fan | \| FAN.1A | \| 1.1.0 | \| Off | \| |
| \| 4 | \| Top Cooler | \| C1-AX | \| 2.3.5 | \| Running | \| |
| \| 5 | \| Bot Cooler | \| C1-AX | \| 2.3.5 | \| Running | \| |
| +-------- | +------------ | +-------- | +--------- | +--------- | + |

(virtual_python) vagrant@demo-machine:~$

Step 3.2.3.3: saving generated template to template storage.

```
(virtual_python) vagrant@demo-machine:~$
(virtual_python) vagrant@demo-machine:~$ dgs build template
“digits(var_module) words(var_name) mixed_word(var_model)
version(var_version) word(var_status) end(space) −> record” --
author=“user1” --email=“user1@abc_xyz.com” --company=“ABC XYZ
Inc.”
################################################################
###############
# Template is generated by templateapp Community Edition
# Created by : :user1
# Email : :useri@abc_xyz.com
# Company : ABC XYZ Inc.
# Created date: 2022-05-27
################################################################
###############
Value module (\d+)
Value name ([a-zA-Z0-9]+( [a-zA-Z0-9]+) *)
Value model (\S*[a-zA-Z0-9] \S*)
Value version ([0-9]\S*)
Value status ([a-zA-Z0-9]+)
Start
  \hat{ }${module} +${name} +${model} +${version} +${status} *$$ −>
Record
(virtual_python) vagrant@demo-machine:~$
(virtual_python) vagrant@demo-machine:~$ dgs build template
“digits(var_module) words(var_name) mixed_word(var_model)
version(var_version) word(var_status) end(space) −> record” --
author=“user1” -- email=“useri@abc_xyz.com” --company=“ABC XYZ
Inc.” --template-id=“unrealos.show_modules” --replaced
+----------------------------------------------------------------
--------------+
| +++ Successfully uploaded generated template to
“unrealos.show_modules” |
| template ID.
|
+----------------------------------------------------------------
--------------+
(virtual_python) vagrant@demo-machine:~$
(virtual_python) vagrant@demo-machine:~$ dgs search template
unrealos.show_modules
+----------------------------------------------------------------
--------------+
| Found 1 template ID(s) matching “unrealos.show_modules”
pattern: |
| - unrealos.show_modules
|
+----------------------------------------------------------------
--------------+
+----------------------------------------------------------------
--------------+
| Template ID:unrealos.show modules
|
+----------------------------------------------------------------
--------------+
################################################################
###############
# Template is generated by templateapp Community Edition
# Created by : user1
# Email : user1@abc xyz.com
# Company : ABC XYZ Inc.
# Created date:2022-05-27
################################################################
###############
Value module (\d+)
Value name ([a-zA-Z0-9]+( [a-zA-Z0-9]+)*)
Value model (\S*[a-zA-Z0-9]\S*)
Value version ([0-9]\s*)
Value status ([a-zA-Z0-9]+)
Start
  \hat{ }${module} +${name} +${model} +${version} +${status} +$$ −>
Record
(virtual_python) vagrant@demo-machine:~$
```

Step 3.2.4: Creating verification and test.

(virtual_python) vagrant@demo-machine:~$ dgs test --
adaptor=unreal-device --action=“1.1.1.1 execute show modules
using-template unrealos.show_modules select * where status ==
Running MUST BE EQUAL_TO 4 --tabular”
login unreal-device 1.1.1.1@dummy_username:dummy_password
May 27 2022 22:59:32.631 for “device719” - UNREAL-DEVICE-
AUTHENTICATION-SERVICE-TIMESTAMP
device719 is successfully connected.
show modules
May 27 2022 22:59:33.990 for “device719” - UNREAL-DEVICE-
EXECUTION-SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

logout unreal-device 1.1.1.1
May 27 2022 22:59:35.361 for “device719” - UNREAL-DEVICE-
AUTHENTICATION-SERVICE-TIMESTAMP
device719 is disconnected.
UnrealDeviceMessage: +++ Successfully released 1.1.1.1 unreal-
device.
+----------------------------------------------------------------
--------------+
| Parsed Results:
|
| SELECT-STATEMENT: select * where status == Running
|
+----------------------------------------------------------------
--------------+

| | | | | | |
|---|---|---|---|---|---|
| +-------- | +------------ | +-------- | +--------- | +--------- | + |
| \| module | \| name | \| model | \| version | \| status | \| |
| +-------- | +------------ | +-------- | +--------- | +--------- | + |
| \| 1 | \| Left Fan | \| FAN.1A | \| 1.1.0 | \| Running | \| |
| \| 2 | \| Right Fan | \| FAN.2C | \| 1.3.7 | \| Running | \| |
| \| 3 | \| Misc Fan | \| FAN.1A | \| 1.1.0 | \| Off | \| |
| \| 4 | \| Top Cooler | \| C1-AX | \| 2.3.5 | \| Running | \| |
| \| 5 | \| Bot Cooler | \| C1-AX | \| 2.3.5 | \| Running | \| |
| +-------- | +------------ | +-------- | +--------- | +--------- | + |

+----------------------------------------------------------------
--------------+
| Verification:
|
| CONDITION:MUST BE EQUAL_TO 4
|
| STATUS : Passed
|
+----------------------------------------------------------------
--------------+
(total found records: 4) == (expected total count: 4)
(virtual_python) vagrant@demo-machine:~$

Step 3.2.5: substituting iterative verification 1 section development to describing snippet.

setup
connect device 1.1.1.1
section: precondition
1.1.1.1 execute show version
section: verify that there are 4 running modules
1.1.1.1 execute show modules using-template unrealos.show_modules
select * where status == Running MUST BE EQUAL_TO 4
teardown
release device 1.1.1.1

### Build Process

Describing snippet is:

```
setup
  connect device 1.1.1.1
section: precondition
  1.1.1.1 execute show version
section: verify that there are 4 running modules
  1.1.1.1 execute show modules using-template unrealos.show_modules
select * where status == Running MUST BE EQUAL_TO 4
teardown
  release device 1.1.1.1
```

Let's save the above snippet as snippet_testcase1.txt in describing_snippet_files directory.

Generating Unittest script and save to sample_script_files/test_unitest_tc1.py:

```
(virtual_python) vagrant@demo-machine:~$
(virtual_python) vagrant@demo-machine:~$ cat
describing_snippet_files/snippet_testcase1.txt
setup
  connect device 1.1.1.1
section: precondition
  1.1.1.1 execute show version
section: verify that there are 4 running modules
  1.1.1.1 execute show modules using-template
unrealos.show_modules select * where status == Running MUST BE
EQUAL_TO 4
teardown
  release device 1.1.1.1
(virtual_python) vagrant@demo-machine:~$
(virtual_python) vagrant@demo-machine:~$ dgs build
unittest_script describing_snippet_files/snippet_testcase1.txt
#################################################################
###############
# unittest script is generated by Describe-Get-System Proof of
Concept
# Created date:2022-05-27
#################################################################
###############
import unittest
import dgspoc as ta
from xmlrunner import XMLTestRunner
def get logger (name=‘TATestScript’):
    “““This function only creates logger instance with
    basic logging configuration.
    ===================================================
    PLEASE UPDATE your get logger function.
    ===================================================
    ”””
    import logging
    logging.basicConfig (
      level=logging.INFO,
      format=“%(asctime)s [%(levelname)s] %(message)s”,
      handlers=[
        logging.FileHandler(‘%s.log’ % name.lower( )),
        logging.StreamHandler( )
      ]
    )
    logger = logging.getLogger(name)
    return logger
class Testclass(unittest.TestCase):
    logger = get_logger( )
    @classmethod
    def setUpClass(cls):
      cls.device1 = ta.connect_device(‘1.1.1.1’)
    @classmethod
    def tearDownClass(cls):
      ta.release_device(cls.device1)
    def test_001_precondition(self):
      “““precondition”””
      ta.execute(self.device1, cmdline=‘show version’)
    def test_002_verify_that_there_are_4_running_modules(self):
      “““verify that there are 4 running modules”””
      output = ta.execute(self.device1, cmdline=‘show modules')
      result = ta.convert_and_filter(
        output, convertor=‘template’,
template_ref=‘unrealos.show_modules',
        select_statement=‘select * where status == Running’
      )
      total_count = len(result)
      self.assertTrue(total_count == 4)
if _{——}name_{——} == ‘_{——}main_{——}’:
    unittest.main(
      testRunner=XMLTestRunner(output=“report”),
      failfast=False, buffer=False, catchbreak=False
    )
(virtual_python) vagrant@demo-machine:~$
(virtual_python) vagrant@demo-machine:~$ dgs build
unittest_script describing_snippet_files/snippet_testcase1.txt --
save-to=sample_script_files/test_unittest_tc1.py
2022-05-28 00:02:11.364467 -
/home/vagrant/sample_script_files/test_unittest_tc1.py file is
created.
+----------------------------------------------------------------
--------------+
| +++ Successfully saved the generated test script to
|
| sample script files/test unittest tc1.py
|
+----------------------------------------------------------------
--------------+
(virtual_python) vagrant@demo-machine:~$
```

Generating pytest script and save to sample_script_files/test_pytest_tc1.py:

```
(virtual_python) vagrant@demo-machine:~$
(virtual_python) vagrant@demo-machine:~$ dgs build pytest_script
describing_snippet_files/snippet_testcase1.txt
#################################################################
###############
# pytest script is generated by Describe-Get-System Proof of
Concept
# Created date: 2022-05-28
#################################################################
###############
# import pytest
import dgspoc as ta
def get_logger(name=‘TATestScript’):
  “““This function only creates logger instance with
  basic logging configuration.
  ==================================================
  PLEASE UPDATE your get_logger function.
  ==================================================
  ”””
  import logging
  logging.basicConfig(
    level=logging.INFO,
    format=“%(asctime)s [%(levelname)s] %(message)s”,
    handlers=[
      logging.FileHandler(‘%s.log’ % name.lower( )),
      logging.StreamHandler( )
    ]
  )
  logger = logging.getLogger(name)
  return logger
class Testclass:
  logger = get_logger( )
  def setup_class(self) :
    self.device1 = ta.connect_device(‘1.1.1.1’)
  def teardown_class(self) :
    ta.release_device(self.device1)
  def test_001_precondition(self):
    “““precondition”””
    ta.execute(self.device1, cmdline=‘show version’)
  def test_002_verify_that_there_are_4_running_modules(self):
    “““verify that there are 4 running modules”””
    output = ta.execute(self.device1, cmdline=‘show modules')
    result = ta.convert_and_filter(
      output, convertor=‘template’,
template_ref=‘unrealos.show_modules',
      select_statement=‘select * where status == Running’
    )
    total_count = len(result)
    assert total_count == 4
(virtual_python) vagrant@demo-machine:~$
(virtual_python) vagrant@demo-machine:~$ dgs build pytest_script
describing_snippet_files/snippet_testcase1.txt --save-
to=sample_script_files/test_pytest_tc1.py
2022-05-28 00:04:13.305667 -
/home/vagrant/sample_script_files/test_pytest_tc1.py file is
created.
+----------------------------------------------------------------
--------------+
| +++ Successfully saved the generated test script to
|
| sample_script_files/test_pytest_tc1.py
|
+----------------------------------------------------------------
--------------+
(virtual_python) vagrant@demo-machine:~$
```

Generating robotframework script and save to
sample_script_files/test_robotframework_tc1.robot:

(virtual_python) vagrant@demo-machine:~$ dgs build
robotframework_script
describing_snippet_files/snippet_testcase1.txt
#################################################################
###############
# robotframework script is generated by Describe-Get-System Proof
of Concept
# Created date: 2022-05-28
#################################################################
###############
*** Settings ***

| | |
|---|---|
| Library | BuiltIn |
| Library | Collections |
| Library | dgspoc.robotframeworklib |
| Suite Setup | setup |
| Suite Teardown | teardown |

```
*** Keywords ***
setup
  ${device1}= connect device 1.1.1.1
  set global variable ${device1}
teardown
  release device ${device1}
*** Test Cases ***
test 001 precondition
  [Documentation] precondition
  execute ${device1} cmdline=show version
test 002 verify that there are 4 running modules
  [Documentation] verify that there are 4 running modules
  ${output}= execute ${device1} cmdline=show modules
  ${result}= convert_and_filter
  ... ${output} convertor=template
template_ref=unrealos.show_modules
  ... select_statement=select * where status == Running
  ${total count}= get length ${result}
  should be true ${total count} == 4
(virtual_python) vagrant@demo-machine:~$
(virtual_python) vagrant@demo-machine:~$
(virtual_python) vagrant@demo-machine:~$ dgs build
robotframework_script
describing_snippet_files/snippet_testcase1.txt --save-
to=sample_script_files/test_robotframework_tc1.robot
+----------------------------------------------------------------
--------------+
| +++ Successfully saved the generated test script to
|
| sample_script_files/test_robotframework_tc1.robot
|
+----------------------------------------------------------------
--------------+
(virtual_python) vagrant@demo-machine:~$
```

### Execute Process

Create Unittest batch script, save to tc1_unittest_batch.bat file, and execute:

(virtual_python) vagrant@demo-machine:~$
(virtual_python) vagrant@demo-machine:~$ dgs build batch
unittest=sample_script_files --save-to=tc1_unittest_batch.bat --
detail
+++ Successfully saved ‘tc1_unittest_batch.bat’ batch file.
(virtual_python) vagrant@demo-machine:~$
(virtual_python) vagrant@demo-machine:~$ cat
tc1_unittest_batch.bat
python -m xmlrunner discover dgs_test_script_files/unittest --
output-file=unittest_report_2022May31_183414.xml
dgs report --detail
dgs --delete=dgs_test_script_files --quiet(virtual_python)
vagrant@demo-machine:~ $
(virtual_python) vagrant@demo-machine:~$
(virtual_python) vagrant@demo-machine:~$
(virtual_python) vagrant@demo-machine:~$ bash
tc1_unittest_batch.bat
Running tests...
------------------------------------------------------------------
-----
login unreal-device 1.1.1.1@dummy_username:dummy_password
May 31 2022 18:34:57.302 for “device774” - UNREAL-DEVICE-
AUTHENTICATION-SERVICE-TIMESTAMP
device774 is successfully connected.
show version
May 31 2022 18:34:58.638 for “device774” - UNREAL-DEVICE-
EXECUTION-SERVICE-TIMESTAMP
Geeks Trident Unreal Device OS Software, Unreal-Device-OS,
Version 1.1.3
Technical Support: http://www.geekstrident.com
Compiled 2022-Jan-01 08:00 by generated_script
Device uptime is 21 weeks, 3 days, 10 hours, 34 minutes
.show modules
May 31 2022 18:34:59.996 for “device774” - UNREAL-DEVICE-
EXECUTION-SERVICE-TIMESTAMP

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

.logout unreal-device 1.1.1.1
May 31 2022 18:35 :01.345 for “device774” - UNREAL-DEVICE-
AUTHENTICATION-SERVICE-TIMESTAMP
device774 is disconnected.
UnrealDeviceMessage: +++ Successfully released 1.1.1.1 unreal-
device.
------------------------------------------------------------------
-----
Ran 2 tests in 5.419s
OK
Generating XML reports...
+----------------------------------------------------------------
--------------+
| Unittest Report - Unittest 3.6.9 - Python 3.6.9 on Linux
|
| ------------------------------------------------------------
|Total Test Cases: 1 / Passed: 1 / Failed:
|
+----------------------------------------------------------------
--------------+
- Test case:
dgs_test_script_files/unittest/test_unittest_tc1.py (Total: 2 /
Passed: 2 / Failed: 0 / Skipped: 0)
(virtual_python) vagrant@demo-machine:~$

Create pytest batch script, save to tc1_pytest_batch.bat file, and execute:

(virtual_python) vagrant@demo-machine:~$
(virtual_python) vagrant@demo-machine:~$ dgs build batch
pytest=sample_script_files --save-to=tc1_pytest_batch.bat --
detail
+++ Successfully saved ‘tc1_pytest_batch.bat’ batch file.
(virtual_python) vagrant@demo-machine:~$
(virtual_python) vagrant@demo-machine:~$ cat tc1_pytest_batch.bat
python -m pytest --junitxml=pytest_report_2022May31 183610.xml
dgs_test_script_files/pytest
dgs report --detail
dgs --delete=dgs_test_script_files --quiet(virtual_python)
vagrant@demo-machine:~$
(virtual_python) vagrant@demo-machine:~$
(virtual_python) vagrant@demo-machine:~$ bash
tc1_pytest_batch.bat
===================================================== test
session starts
=====================================================
platform linux -- Python 3.6.9, pytest-7.0.1, pluggy-1.0.0
rootdir: /home/vagrant
collected 2 items
dgs_test_script_files/pytest/test_pytest_tcl.py ..
[100%]
----------------------------- generated xml file:
/home/vagrant/pytest_report_2022May31_183610.xml ----------------
-------------
====================================================== 2 passed
in 5.57s =======================================================
+----------------------------------------------------------------
--------------+
| Pytest Report - Pytest 7.0.1 - Python 3.6.9 on Linux
|
| ----------------------------------------------------
|
| Total Test Cases: 1 / Passed: 1 / Failed: 0
|
+----------------------------------------------------------------
--------------+
- Test case: dgs_test_script_files.pytest.test_pytest_tc1
(Total: 2 / Passed: 2 / Failed: 0 / Skipped: 0)
(virtual—python) vagrant@demo-machine:~$
(virtual—python) vagrant@demo-machine:~$

Create robotframework batch script, save to tc1_robotframework_batch.bat file, and execute:

(virtual_python) vagrant@demo-machine:~$
(virtual_python) vagrant@demo-machine:~$ dgs build batch
robotframework=sample_script_files --save-
to=tc_robotframework_batch.bat --detail
+++ Successfully saved ‘tc_robotframework_batch.bat’ batch file.
(virtual_python) vagrant@demo-machine:~$
(virtual_python) vagrant@demo-machine:~$
(virtual_python) vagrant@demo-machine:~$ cat
tc_robotframework_batch.bat
python -m robot --
output=robotframework_output_2022May31_183736.xml --
log=robotframework_log_2022May31_183736.html --
report=robotframework_report_2022May31_183736.html
dgs_test_script_files/robotframework
dgs report --detail
dgs --delete=dgs_test_script_files --quiet(virtual_python)
vagrant@demo-machine:~$
(virtual_python) vagrant@demo-machine:~$
(virtual_python) vagrant@demo-machine:~$ bash
tc_robotframework_batch.bat
=================================================================
==============
Robotframework
=================================================================
==============
Robotframework.Test Robotframework Tc1
=================================================================
==============
test 001 precondition :: precondition
PASS |
-----------------------------------------------------------------
--------------
test 002 verify that there are 4 running modules :: verify that
th ...| PASS |
-----------------------------------------------------------------
--------------
Robotframework.Test Robotframework Tc1
| PASS |
2 tests, 2 passed, 0 failed
=================================================================
==============
Robotframework
| PASS |
2 tests, 2 passed, 0 failed
=================================================================
==============
Output: /home/vagrant/robotframework output 2022May31 183736.xml
Log: /home/vagrant/robotframework log 2022May31 183736.html
Report:
/home/vagrant/robotframework report 2022May31 183736.html
+----------------------------------------------------------------
--------------+
| Robotframework Report - Robot 5.0.1 - Python 3.6.9 on Linux
|
| ------------------------------------------------------------
|
| Total Test Cases: 1 / Passed: 1 / Failed: 0
|
+----------------------------------------------------------------
--------------+
- Test case: Robotframework.Test Robotframework Tc1 (Total: 2 /
Passed: 2 / Failed: 0 / Skipped: 0)
(virtual_python) vagrant@demo-machine:~$
(virtual_python) vagrant@demo-machine:~$

### Review Process

Reviewing Unittest Test Result:

unittest_report_yyyymmmdd_HHMMSS.xml is created after executed “bash tc1_unittest_batch.bat”. The report is generated by unittest-xml-reporting package. To view the summary report, execute “dgs report-detail”. If users want to sync unittest_report_yyyymmmdd_HHMMSS.xml to working directory for more review, users can copy it to/vagrant folder.

+---------------------------------------------------------------
--------------+
| Unittest Report - Unittest 3.6.9 - Python 3.6.9 on Linux
|
| -------------------------------------------------------
|
| Total Test Cases: 1 / Passed: 1 / Failed: 0
|
+---------------------------------------------------------------
--------------+
- Test case:
dgs_test_script_files/unittest/test_unittest_tc1.py (Total: 2 /
Passed: 2 / Failed: 0 / Skipped: 0)

### Reviewing PyTest Test Result:

+---------------------------------------------------------------
--------------+
| Pytest Report - Pytest 7.0.1 - Python 3.6.9 on Linux
|
| -------------------------------------------------------
|
| Total Test Cases: 1 / Passed: 1 / Failed: 0
|
+---------------------------------------------------------------
--------------+
- Test case: dgs_test_script_files.pytest.test_pytest_tc1
(Total: 2 / Passed: 2 / Failed: 0 / Skipped: 0)

### Reviewing Robotframework Test Result:

robotframework_output_yyyymmmdd_HHMMSS.xml, robotframework_log_yyyymmmdd_HHMMSS.html, and robotframework_report_yyyymmmdd_HHMMSS.html are created after executed “bash tc1_robotframework_batch.bat”. The report is generated by robotframework package. To view the summary report, execute “dgs report-detail”. If users want to sync those above files to working directory for more review, users can copy them to/vagrant folder.

+-----------------------------------------------------------------
--------------+
| Robotframework Report - Robot 5.0.1 - Python 3.6.9 on Linux
|
| -------------------------------------------------------
|
| Total Test Cases: 1 / Passed: 1 / Failed: 0
|
+----------------------------------------------------------------
--------------+
- Test case: Robotframework.Test Robotframework Tc1 (Total: 2 /
Passed: 2 / Failed: 0 / Skipped: 0)

To view the test result step by step, users can open robotframework_log_yyyymmmdd_HHMMSS.html on browser.

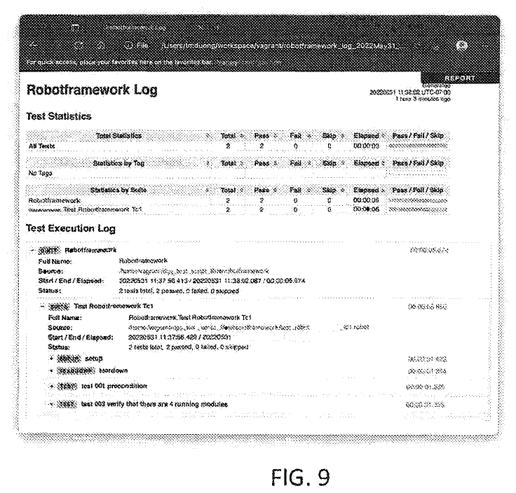

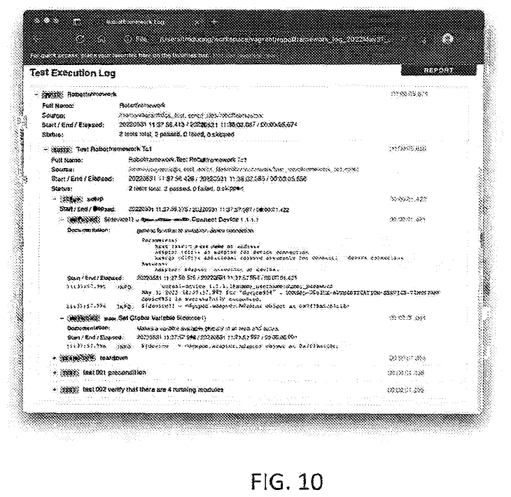

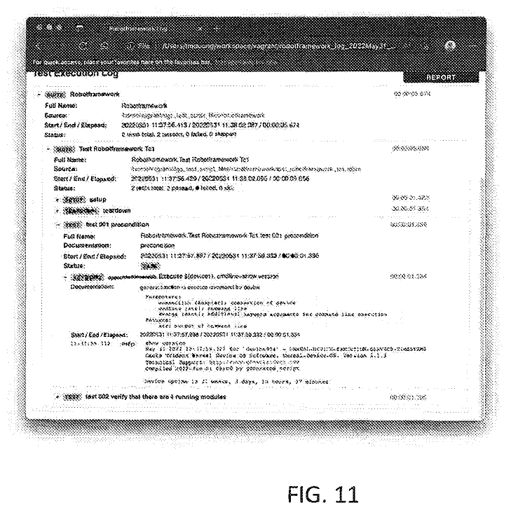

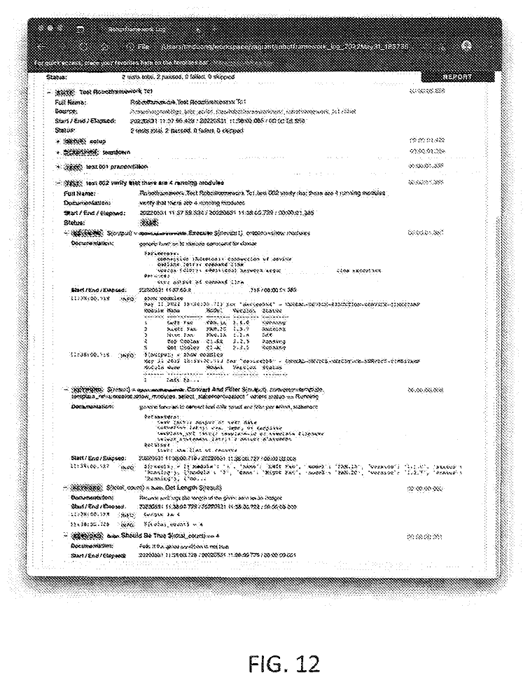

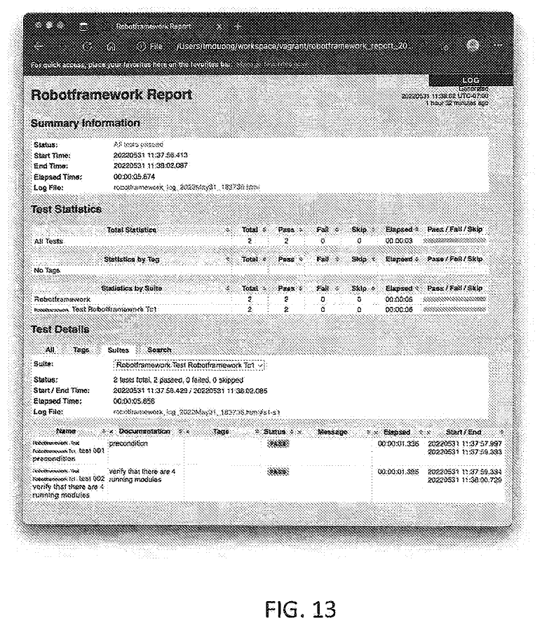

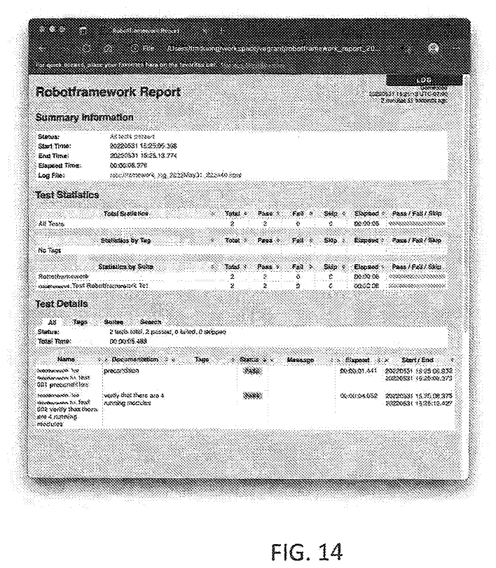

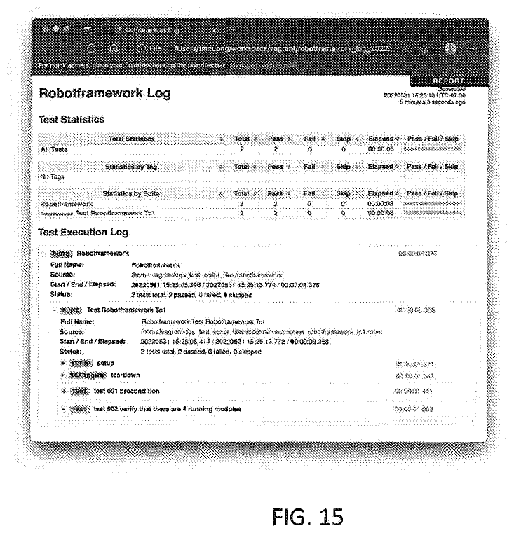

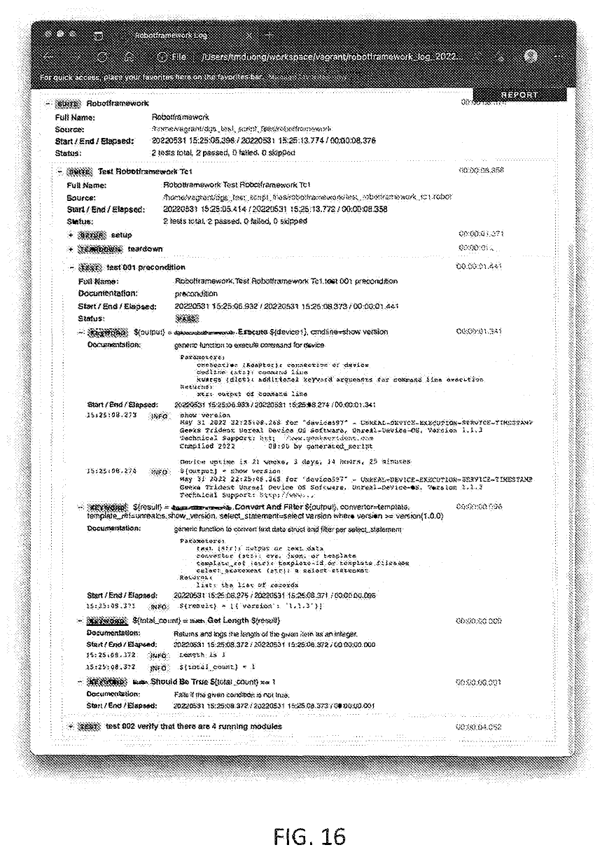

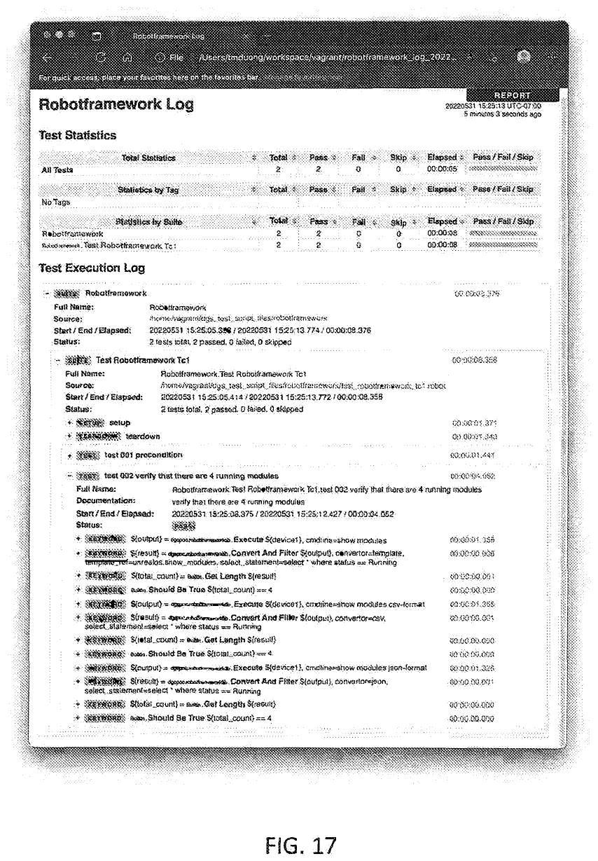

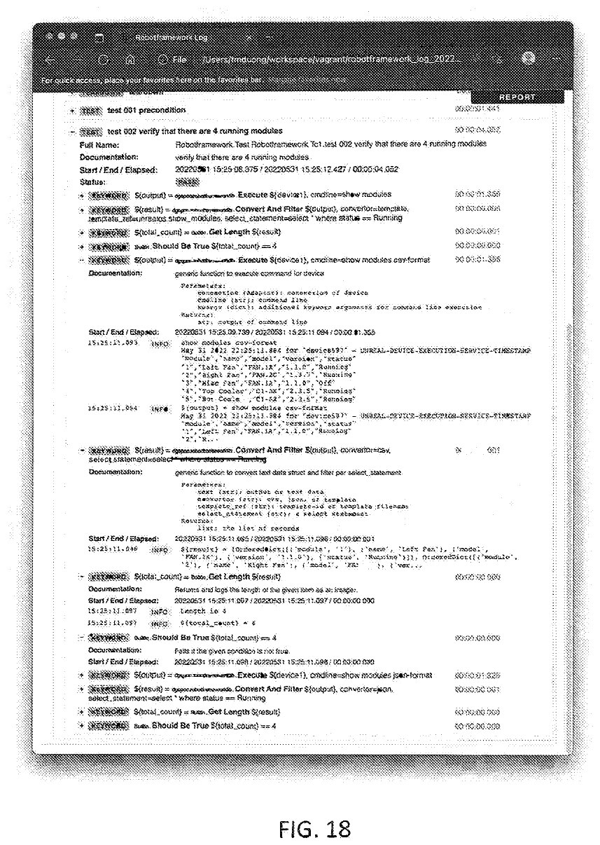

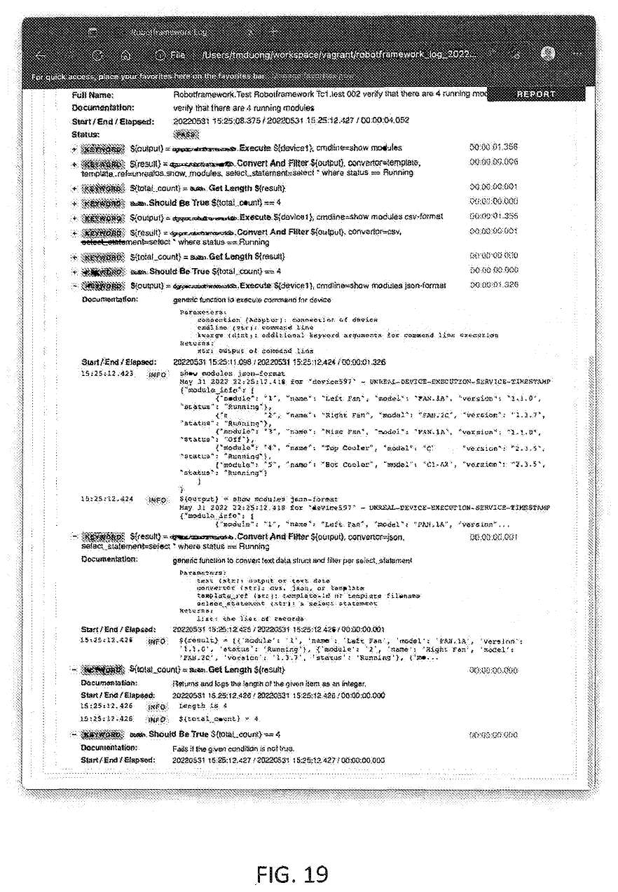

FIGS. 9 through 13 show an exemplary result from the Robotframework test of this invention, illustrating an embodiment of a Robotframework log of this invention. FIGS. 10 through 13 illustrate embodiments of a Test Execution Log from a Robotframework test of this invention.

### Adopt Process

Current test procedure:

```
Device: using unreal-device with host address 1.1.1.1
Test Procedure:
  Precondition: execute command line “show version”
  Verification 1: using “show modules” command line to verify
  that there are 4 running modules
```

New test procedure:

```
  Device: using unreal-device with host address 1.1.1.1
  Test Procedure:
    Precondition: using “show version” command to verify that
    its software version must be newer than 1.0.0
    Verification 1:
using “show modules” command line to verify that there are 4 running
modules
using “show modules csv-format” command line to verify that there are
4 running modules
using “show modules json-format” command line to verify that there are
4 running modules
```

Executing highlight below command lines:

(virtual_python) vagrant@demo-machine:~$
(virtual_python) vagrant@demo-machine:~$ dgs build template
“mixed_words( ), Unreal-Device-OS, Version version(var_version)
end(space)” --template-id=“unrealos.show_version” --replaced --
author=“user1” --email=“user1@abc xyz.com” --company=“ABC XYZ
Inc.”
+----------------------------------------------------------------
--------------+
| +++ Successfully uploaded generated template to
“unrealos.show_version” |
| template ID.
|
+----------------------------------------------------------------
--------------+
(virtual_python) vagrant@demo-machine:~$
(virtual_python) vagrant@demo-machine:~$ dgs build template
unrealos.show_version
+----------------------------------------------------------------
--------------+
| Found 1 template ID(s) matching “unrealos.show_version”
pattern: |
| - unrealos.show_version
|
+----------------------------------------------------------------
--------------+
+----------------------------------------------------------------
--------------+
| Template ID: unrealos.show_verion
|
+----------------------------------------------------------------
--------------+
#################################################################
###############
# Template is generated by templateapp Community Edition

| # Created by | : user1 |
|---|---|
| # Email | : user1@abc xyz.com |
| # Company | : ABC XYZ Inc. |
| # Created date | : 2022-05-31 |

#################################################################
###############
Value version ([0-9]\S*)
Start
\hat{ }\S*[a-zA-Z0-9]\S*( \S*[a-zA-Z0-9]\S*)*, Unreal-Device-OS,
Version ${version} *$$
(virtual_python) vagrant@demo-machine:~$
(virtual_python) vagrant@demo-machine:~$
(virtual_python) vagrant@demo-machine:~$ dgs test --
adapter=“unreal-device” --action“1.1.1.1 execute show version
using-template=unrealos.show_verion select version where version
>= version (1.0.0) must be ture --showed --tabular”
login unreal-device 1.1.1.1@dummy_username:dummy_password
May 31 2022 20:34:34.341 for “device958” - UNREAL-DEVICE-
AUTHENTICATION-SERVICE-TIMESTAMP
device958 is successfully connected.
show version
May 31 2022 20:34:35.698 for “device958” - UNREAL-DEVICE
EXECUTION-SERVICE-TIMESTAMP
Geeks Trident Unreal Device OS Software, Unreal-Device-OS,
Version 1.1.3
Technical Support: http://www.geekstrident.com
Compiled 2022-Jan-01 08:00 by generated_script
Device uptime is 21 weeks, 3 days, 12 hours, 34 minutes
logout unreal-device 1.1.1.1
May 31 2022 20:34:37.337 for “device958” - UNREAL-DEVICE-
AUTHENTICATION-SERVICE-TIMESTAMP
device958 is disconnected.
UnrealDeviceMessage: +++ Successfully released 1.1.1.1 unreal-
device
+----------------------------------------------------------------
--------------+
| User Test Data:
|
+----------------------------------------------------------------
--------------+
show version
May 31 2022 20:34:35.698 for “device958” - UNREAL-DEVICE-
EXECUTION-SERVICE-TIMESTAMP
Geeks Trident Unreal Device OS Software, Unreal-Device-OS,
Version 1.1.3
Technical Support: http://www.geekstrident.com
Compiled 2022-Jan-01 08:00 by generated_script
Device uptime is 21 weeks, 3 days, 12 hours, 34 minutes
+----------------------------------------------------------------
--------------+
| Template:
|
+----------------------------------------------------------------
--------------+
#################################################################
###############
# Template is generated by templateapp Community Edition

| | |
|---|---|
| # Created by | : user1 |
| # Email | : user1@abc xyz.com |
| # Company | : ABC XYZ Inc. |
| # Created date | : 2022-05-31 |

#################################################################
###############
Value version ([0-9]\S*)
Start
\hat{ }\S*[a-zA-Z0-9]\S*( \S*[a-zA-Z0-9]\S*)*, Unreal-Device-OS,
Version ${version} *$$
+----------------------------------------------------------------
--------------+
| Parsed Results:
|
| SELECT-STATEMENT: select version where version >=
version(1.0.0) |
+----------------------------------------------------------------
--------------+

| | |
|---|---|
| +--------- | + |
| \| version | \| |
| +--------- | + |
| \| 1.1.3 | \| |
| +--------- | + |

+----------------------------------------------------------------
--------------+
| Verification
|
| CONDITION: must be true
|
| STATUS : Passed
|
+----------------------------------------------------------------
--------------+
(total found records: 1) == (expected total count: 1)
(virtual_python) vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$ dgs test --
adapter=“unreal-device” --action=“1.1.1.1 execute show modules
csv-format using-csv select * where status == Running must be ==
4 --tabular”
login unreal-device 1.1.1.1@dummy_username:dummy_password
May 31 2022 20:37:12.928 for “device117” - UNREAL-DEVICE-
AUTHENTICATION-SERVICE-TIMESTAMP
device117 is successfully connected.
show modules csv-format
May 31 2022 20:37:14.274 for “device117” - UNREAL-DEVICE-
EXECUTION-SERVICE-TIMESTAMP
“module”,“name”,“model”,“version”,“status”
“1”,“Left Fan”,“FAN.1A”,“1.1.0”,“Running”
“2”,“Right Fan”,“Fan.2C”,“1.3.7”,“Running”
“3”,“Misc Fan”,“FAN.1A”,“1.1.0”,“Off”
“4”,“Top Cooler”,“C1-AX”,“2.3.5”,“Running”
“5”,“Bot Cooler”,“C1-AX”,“2.3.5”,“Running”
logout unreal-device 1.1.1.1
May 31 2022 20:37:15.605 for “device117” - UNREAL-DEVICE-
AUTHENTICATION-SERVICE-TIMESTAMP
device117 is disconnected.
UnrealDeviceMessage: +++ Successfully released 1.1.1.1 unreal-
device.
+----------------------------------------------------------------
--------------+
| Parsed Results:
|
| SELECT-STATEMENT: select * where status == Running
|
+----------------------------------------------------------------
--------------+

| | | | | | |
|---|---|---|---|---|---|
| +--------- | +----------- | +-------- | +--------- | +--------- | + |
| \| module | \| name | \| model | \| version | \| status | \| |
| +-------- | +------------ | +-------- | +--------- | +--------- | + |
| \| 1 | \| Left Fan | \| FAN. 1A | \| 1.1.0 | \| Running | \| |
| \| 2 | \| Right Fan | \| FAN.2C | \| 1.3.7 | \| Running | \| |
| \| 4 | \| Top Cooler | \| C1-AX | \| 2.3.5 | \| Running | \| |
| \| 5 | \| Bot Cooler | \| C1-AX | \| 2.3.5 | \| Running | \| |
| +-------- | +------------ | +-------- | +--------- | +--------- | + |

```
+----------------------------------------------------------------
--------------+
| Verification:
|
| CONDITION: must be == 4
|
| STATUS : Passed
|
+----------------------------------------------------------------
--------------+
(total found records: 4) == (expected total count: 4)
(virtual_python) vagrant@demo-machine:~$
(virtual_python) vagrant@demo-machine:~$
(virtual_python) vagrant@demo-machine:~$ dgs test --
adapter=“unreal-device” --action=“1.1.1.1 execute show modules
json-format using-json select * where == Running must be
== 4 --tabular”
login unreal-device 1.1.1.1@dummy_username:dummy_password
May 31 2022 20:37:35.701 for “device140” - UNREAL-DEVICE-
AUTHENTICATION-SERVICE-TIMESTAMP
device140 is succesfully connected.
show modules json-format
May 31 2022 20:37:37.503 for “device140” - UNREAL-DEVICE-
EXECUTION-SERVICE-TIMESTAMP
{“module_info”: [
        {“module”: “1”, “name”: “Left Fan”, “model”: “FAN.1A”,
“version”: “1.1.0”, “status”: “Running”},
        {“module”: “2”, “name”: “Right Fan”, “model”: “FAN.2C”,
“version”: “1.3.7”, “status”: “Running”},
        {“module”: “3”, “name”: “Misc Fan”, “model”: “FAN.1A”,
“version”: “1.1.0”, “status”: “Off”},
        {“module”: “4”, “name”: “Top Cooler”, “model”: “C1-AX”,
“version”: “2.3.5”, “status”: “Running”},
        {“module”: “5”, “name”: “Bot Cooler”, “model”: “C1-AX”,
“version”: “2.3.5”, “status”: “Running”},
    ]
}
logout unreal-device 1.1.1.1
May 31 2022 20:37:38:392 for “device140” - UNREAL-DEVICE-
AUTHENTICATION-SERVICE-TIMESTAMP
device140 is disconnected.
UnrealDeviceMessage: +++ Successfully released 1.1.1.1 unreal-
device.
+----------------------------------------------------------------
--------------+
| Parsed Results:
|
| SELECT-STATEMENT: select * where status == Running
|
+----------------------------------------------------------------
--------------+
```

| | | | | | |
|---|---|---|---|---|---|
| +--------- | +----------- | +-------- | +--------- | +--------- | + |
| \| module | \| name | \| model | \| version | \| status | \| |
| +-------- | +------------ | +-------- | +--------- | +--------- | + |
| \| 1 | \| Left Fan | \| FAN.1A | \| 1.1.0 | \| Running | \| |
| \| 2 | \| Right Fan | \| FAN.2C | \| 1.3.7 | \| Running | \| |
| \| 4 | \| Top Cooler | \| C1-AX | \| 2.3.5 | \| Running | \| |
| \| 5 | \| Bot Cooler | \| C1-AX | \| 2.3.5 | \| Running | \| |
| +-------- | +------------ | +-------- | +--------- | +--------- | + |

+----------------------------------------------------------------
--------------+
| Verification:
|
| CONDITION: must be == 4
|
| STATUS : Passed
|
+----------------------------------------------------------------
--------------+
(total found records: 4) == (expected total count: 4)
(virtual_python) vagrant@demo-machine:~$
(virtual_python) vagrant@demo-machine:~$

The new describing snippet is:

```
setup
  connect device 1.1.1.1
section: precondition
  1.1.1.1 execute show version using-template
unrealos.show_version select version where version >=
version(1.0.0) must be True
section: verify that there are 4 running modules
  1.1.1.1 execute show modules using-template unrealos.show_modules
select * where status == Running MUST BE EQUAL_TO 4
1.1.1.1 execute show modules csv-format using-csv select * where
status == Running MUST BE EQUAL_TO 4
  1.1.1.1 execute show modules json-format using-json select * where
status == Running MUST BE EQUAL_TO 4
teardown
  release device 1.1.1.1
```

Generating Unittest script, execute test, and creating report:

```
(virtual_python) vagrant@demo-machine:~$
(virtual_python) vagrant@demo-machine:~$ dgs build
unittest_script describing_snippet_files/snippet_textcase1.txt --
save-to=sample_script_files/test_unittest_tc1.py
+----------------------------------------------------------------
--------------+
| +++ Successfully saved the generates test script to
|
| sample_script_files/test_unittest_tc1.py
|
+----------------------------------------------------------------
--------------+
(virtual_python) vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$ cat
sample_script_files/test_unittest_tc1.py
#################################################################
###############
# unittest script is generated by Describe-Get-System Proof of
Concept
# Created date: 2022-05-31
#################################################################
###############
import unittest
import dgspoc as ta
from xmlrunner import XMLTestRunner
def get_logger(name=‘TATestScript’):
    “““This function only created logger instance with
    basic logging configuration
    ===================================================
    PLEASE UPDATE your get_logger function.
    ===================================================
    ”””
    import logging
    logging.basicConfig(
      level=logging.INFO,
      format=“%(asctime)s [%(levelname)s] %(message)s”,
      handlers=[
        logging.FileHandler(‘%s.log’ % name.lower( )),
        logging.StreamHandler( )
      ]
    )
    logger = logging.getLogger(name)
    return logger
class TestClass(unittest.TestCase):
    logger = get_logger( )
    @classmethod
    def setUpClass(cls):
      cls.device1 = ta.connect_device(‘1.1.1.1’)
    @classmethod
    def tearDownClass(cls):
      ta.release_device(cls.device1)
    def test_001_precondition(self):
      “““precondition”””
      output = ta.execute(self.device1, cmdline=‘show version’)
      result = ta.convert_and_filter(
        output, convertor=‘template’,
template_ref=‘unrealos.show_version’,
        select_statement=‘select version where version >=
version(1.0.0)’
      )
      total_count = len(result)
      self.assertTrue(total_count == 1)
    def test_002_verify_that_there_are_4_running_modules(self):
      “““verify that there are 4 running modules”””
      output = ta.execute(self.device1, cmdline=‘show modules’)
      result = ta.convert_and_filter(
        output, convertor=‘template’,
template_ref=‘unrealos.show_modules’,
        select_statement=‘select * where status == Running’
      )
      total_count = len(result)
      self.assertTrue(total_count == 4)
      output = ta.execute(self.device1, cmdline=‘show modules
csv-format’)
      result = ta.convert_and_filter(
        output, converter=‘csv’,
        select_statement=‘select * where status == Running’
      )
      total_count = len(result)
      self.assertTrue(total_count == 4)
      output = ta.execute(self.device1, cmdline=‘show modules
json-format’)
      result = ta.convert_and_filter(
        output, converter=‘json’,
        select_statement=‘select * where status == Running’
      )
      total_count = len(result)
      self.assertTrue(total_count == 4)
if _{——}name_{——} == ‘_{——}main_{——}’:
    unittest.main(
      testRunner=XMLTestRunner(output=“report”),
      failfast=False, buffer=False, catchbreak=False
    ) (virtual_python) vagrant@demo-machine:~$
(virtual_python) vagrant@demo-machine:~$
(virtual_python) vagrant@demo-machine:~$
(virtual_python) vagrant@demo-machine:~$ dgs build batch
unittest=sample_script_files --save-to=tc_unittest_batch.bat --
detail
+++ Successfully saved ‘tc_unittest_batch.bat’ batch file.
(virtual_python) vagrant@demo-machine:~$
(virtual_python) vagrant@demo-machine:~$
(virtual_python) vagrant@demo-machine:~$ cat
tc_unittest_batch.bat
python -m xmlrunner discover dgs_test_script_files/unittest --
output-file=unittest_report_2022May_221258.xml
dgs report --detail
dgs --delete=dgs_test_script_files --quiet(virtual_python)
vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$ bash
tc_unittest_batch.bat
Running tests ...
-----------------------------------------------------------------
-----
login unreal-device 1.1.1.1@dummy_username:dummy_password
May 31 2022 22:13:19.322 for “device889” - UNREAL-DEVICE-
AUTHENTICATION-SERVICE-TIMESTAMP
device889 is successfully connected.
show version
May 31 2022 22:13:20.658 for “device899” - UNREAL-DEVICE-
EXECUTION-SERVICE-TIMESTAMP
Geeks Trident Unreal Device OS Software, Unreal-Device-OS,
Version 1.1.3
Technical Support: http://www.geekstrident.com
Compiled 2022-Jan-01 08:00 by generated_script
Device uptime is 21 weeks, 3 days, 14 hours, 13 minutes
.show modules
May 31 2022 22: 13:22.514 for “device889” - UNREAL-DEVICE-
EXECUTION-SERVICE-TIMESTAMP
```

| Module | Name | Model | Version | Status |
|---|---|---|---|---|
| ------ | ----------- | ------- | -------- | -------- |
| 1 | Left Fan | FAN.1A | 1.1.0 | Running |
| 2 | Right Fan | FAN.2C | 1.3.7 | Running |
| 3 | Misc Fan | FAN.1A | 1.1.0 | Off |
| 4 | Top Cooler | C1-AX | 2.3.5 | Running |
| 5 | Bot Cooler | C1-AX | 2.3.5 | Running |

```
show modules csv-format
May 31 2022 22: 13:23.389 for “device889” - UNREAL-DEVICE-
EXECUTION-SERVICE-TIMESTAMP
“module”, “name”,“model”,“version”,“status”
“1”,“Left Fan”,“FAN. 1A”,“1.1.0”,“Running”
“2”,“Right Fan”,“FAN. 2C”,“1.3.7”,“Running”
“3”,“Misc Fan”,“FAN. 1A”,“1.1.0”,“Off”
“4” ,“Top Cooler”,“C1-AX”,“2.3.5”,“Running”
“5 “,“Bot Cooler”,“C1-AX”,“2.3.5”,“Running”
show modules json-format
May 31 2022 22:13:24.741 for “device889” - UNREAL-DEVICE-
EXECUTION-SERVICE-TIMESTAMP
{“module info”: [
{“module”: “1”, “name”: “Left Fan”, “model”: “FAN. 1A”,
“version”: “1.1.0”, “status”: “Running”},
{“module”: “2”, “name”: “Right Fan”, “model”: “FAN. 2C”,
“version”: “1.3.7”, “status”: “Running”},
{“module”: “3”, “name”: “Misc Fan”, “model”: “FAN. 1A”,
“version”: “1.1.0”, “status”: “Off”},
{“module”: “4”, “name”: “Top Cooler”, “model”: “C1-AX”,
“version”: “2.3.5”, “status”: “Running”},
{“module”: “5”, “name”: “Bot Cooler”, “model”: “C1-AX”,
“version”: “2.3.5”, “status”: “Running”}
    ]
}
.logout unreal-device 1.1.1.1
May 31 2022 22:13:26.757 for “device889” - UNREAL-DEVICE-
AUTHENTICATION-SERVICE-TIMESTAMP
device889 is disconnected.
UnrealDeviceMessage: +++ Successfully released 1.1.1.1 unreal-
device.
-----------------------------------------------------------------
-----
Ran 2 tests in 8.089s
OK
Generating XML reports...
+----------------------------------------------------------------
--------------+
| Unittest Report - Unittest 3.6.9 - Python 3.6.9 on Linux
|
| --------------------------------------------------------
|
| Total Test Cases: 1 / Passed: 1 / Failed: 0
|
+----------------------------------------------------------------
--------------+
  - Test case:
dgs_test_script_files/unittest/test_unittest_tc1.py (Total: 2 /
Passed: 2 / Failed: 0 / Skipped: 0)
(virtual_python) vagrant@demo-machine:~$
(virtual_python) vagrant@demo-machine:~$
(virtual_python) vagrant@demo-machine:~$
```

Generating pytest script, execute test, and creating report:

```
(virtual_python) vagrant@demo-machine:~$
(virtual_python) vagrant@demo-machine:~$
(virtual_python) vagrant@demo-machine:~$ dgs build pytest_script
describing_snippet_files/snippet_testcase1.txt --save-
to=sample_script_files/test_pytest_tc1.py
+----------------------------------------------------------------
--------------+
| +++ Successfully saved the generated test script to
|
| sample_script_files/test_pytest_tc1.py
|
+----------------------------------------------------------------
--------------+
(virtual_python) vagrant@demo-machine:~$
(virtual_python) vagrant@demo-machine:~$
(virtual_python) vagrant@demo-machine:~$
(virtual_python) vagrant@demo-machine:~$ cat
sample_script_files/test pytest_tc1.py
#################################################################
###############
# pytest script is generated by Describe-Get-System Proof of
Concept
# Created date: 2022-05-31
#################################################################
###############
# import pytest
import dgspoc as ta
def get_logger (name=‘TATestScript’) :
    “““This function only creates logger instance with
    basic logging configuration.
    ===================================================
    PLEASE UPDATE your get_logger function.
    ===================================================
    ”””
    import logging
    logging.basicConfig(
      level=logging.INFO,
      format=“%(asctime)s [%(levelname)s] %(message)s”,
      handlers=[
        logging.FileHandler (‘%s.log’ % name.lower( )) ,
        logging.StreamHandler( )
      ]
    )
    logger = logging.getLogger(name)
    return logger
class TestClass:
    logger = get_logger( )
    def setup_class(self):
      self.device1 = ta.connect device(‘1.1.1.1’)
    def teardown_class(self):
      ta.release_device(self.device1)
    def test_001_precondition(self):
      “““precondition”””
      output = ta.execute(self.device1, cmdline=‘show version’)
      result = ta.convert_and_filter(
        output, convertor=‘template’,
template_ref=‘unrealos.show_version’,
        select_statement=‘select version where version >=
version(1.0.0)’
      )
      total_count = len(result)
      assert total_count == 1
    def test_002_verify_that_there_are_4_running_modules(self):
      “““verify that there are 4 running modules”””
      output = ta.execute(self.device1, cmdline=‘show modules')
      result = ta.convert_and_filter(
        output, convertor=‘template’,
template_ref=‘unrealos.show_modules’,
        select_statement=‘select * where status == Running’
      )
      total_count = len(result)
      assert total_count == 4
      output = ta.execute(self.device1, cmdline=‘show modules
csv-format’)
      result = ta.convert_and_filter(
        output, convertor=‘csv’,
        select_statement=‘select * where status == Running’
      )
      total_count = len(result)
      assert total_count == 4
      output = ta.execute(self.device1, cmdline=‘show modules
json-format’)
      result = ta.convert_and_filter(
        output, convertor=‘json’,
        select_statement=‘select * where status == Running’
      )
      total_count = len(result)
      assert total_count == 4(virtual_python) vagrant@demo-
machine:~$
(virtual_python) vagrant@demo-machine:~$
(virtual_python) vagrant@demo-machine:~$
(virtual_python) vagrant@demo-machine:~$
(virtual_python) vagrant@demo-machine:~$ dgs build batch
pytest=sample_script_files --save-to=tc_pytest_batch.bat --detail
2022-05-31 22:20:52.237148 - /home/vagrant/tc_pytest_batch.bat
file is created.
+++ Successfully saved ‘tc_pytest_batch.bat’ batch file.
(virtual_python) vagrant@demo-machine:~$
(virtual_python) vagrant@demo-machine:~$
(virtual_python) vagrant@demo-machine:~$ cat tc_pytest_batch.bat
python -m pytest --junitxml=pytest_report_2022May31_222052.xml
dgs_test_script_files/pytest
dgs report --detail
dgs --delete=dgs_test_script_files --quiet(virtual_python)
vagrant@demo-machine: ~ $
(virtual_python) vagrant@demo-machine:~$
(virtual_python) vagrant@demo-machine:~$
(virtual_python) vagrant@demo-machine:~$ bash tc_pytest_batch.bat
===================================================== test
session starts
=====================================================
platform linux -- Python 3.6.9, pytest-7.0.1, pluggy-1.0.0
rootdir: /home/vagrant
collected 2 items
dgs_test_script_files/pytest/test pytest_tcl.py..
[100%]
----------------------------- generated xml file:
/home/vagrant/pytest_report_2022May31_222052.xml----------------
-------------
====================================================== 2 passed
in 8.32s =======================================================
+----------------------------------------------------------------
--------------+
| Pytest Report - Pytest 7.0.1 - Python 3.6.9 on Linux
|
| ----------------------------------------------------
|
| Total Test Cases: 1 / Passed: 1 / Failed: 0
|
+----------------------------------------------------------------
--------------+
  - Test case: dgs_test_script_files.pytest.test_pytest_tc1
(Total: 2 / Passed: 2 / Failed: 0 / Skipped: 0)
(virtual_python) vagrant@demo-machine:~$
(virtual_python) vagrant@demo-machine:~$
(virtual_python) vagrant@demo-machine:~$
```

Generating robotframework test script, execute test, and creating report:

(virtual_python) vagrant@demo-machine:~$
(virtual_python) vagrant@demo-machine:~$ dgs build
robotframework_script
describing_snippet_files/snippet_testcase1.txt --save-
to=sample_script_files/test_robotframework_tc1.robot
+----------------------------------------------------------------
--------------+
| +++ Successfully saved the generated test script to
|
| sample_script_files/test_robotframework_tc1.robot
|
+----------------------------------------------------------------
--------------+
(virtual_python) vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$
(virtual_python) vagrant@demo-machine:~$ cat
sample_script_files/test_robotframework_tc1.robot
#################################################################
###############
# robotframework script is generated by Describe-Get-System Proof
of Concept
# Created date: 2022-05-31
#################################################################
###############
*** Settings ***

| | |
|---|---|
| Library | BuiltIn |
| Library | Collections |
| Library | dgspoc.robotframeworklib |
| Suite Setup | setup |
| Suite Teardown | teardown |

```
*** Keywords ***
setup
    ${device1}= connect device 1.1.1.1
    set global variable ${device1}
teardown
    release device ${device1}
*** Test Cases ***
test 001 precondition
    [Documentation] precondition
    ${output}= execute $ {device1} cmdline=show version
    ${result}= convert_and_filter
    ... ${output} convertor=template
template_ref=unrealos.show_version
    ... select_statement=select version where version >=
version (1.0.0)
    ${total_count}= get length ${result}
    should be true ${total_count} == 1
test 002 verify that there are 4 running modules
    [Documentation] verify that there are 4 running modules
    ${output}= execute ${device1} cmdline=show modules
    ${result}= convert_and_filter
    ... ${output} convertor=template
template_ref=unrealos.show_modules
    ... select_statement=select * where status == Running
    ${total_count}= get length ${result}
    should be true ${total_count} == 4
    ${output}= execute ${device1} cmdline=show modules csv-
format
    ${result}= convert_and_filter
    ... ${output} convertor=csv
    ... select_statement=select * where status == Running
    ${total_count}= get length ${result}
    should be true ${total_count} == 4
    ${output}= execute ${device1} cmdline=show modules
json-format
    ${result}= convert_and_filter
    ... ${output} convertor=json
    ... select_statement=select * where status == Running
    ${total_count}= get length ${result}
    should be true ${total_count} == 4 (virtual_python)
vagrant@demo-machine:~$
(virtual_python) vagrant@demo-machine:~$
(virtual_python) vagrant@demo-machine:~$
(virtual_python) vagrant@demo-machine:~$ dgs build batch
robotframework=sample_script_files --save-
to=tc_robotframework_batch.bat --detail
+++ Successfully saved ‘tc_robotframework_batch.bat’ batch file.
(virtual_python) vagrant@demo-machine:~$
(virtual_python) vagrant@demo-machine:~$
(virtual_python) vagrant@demo-machine:~$ cat
tc_robotframework_batch.bat
python -m robot --
output=robotframework_output_2022May31_222440.xml --
log=robotframework_log_2022May31_222440.html --
report=robotframework_report_2022May31_222440.html
dgs_test_script_files/robotframework
dgs report --detail
dgs --delete=dgs_test_script_files --quiet(virtual_python)
vagrant@demo-machine:~$
(virtual_python) vagrant@demo-machine:~$
(virtual_python) vagrant@demo-machine:~$
(virtual_python) vagrant@demo-machine:~$ bash
tc_robotframework_batch.bat
=================================================================
=============
Robotframework
=================================================================
=============
Robotframework.Test Robotframework Tc1
=================================================================
=============
test 001 precondition :: precondition
| PASS |
-----------------------------------------------------------------
-------------
test 002 verify that there are 4 running modules :: verify that
-----------------------------------------------------------------
-------------
th... | PASS |
Robotframework.Test Robotframework Tc1
| PASS |
2 tests, 2 passed, 0 failed
=================================================================
=============
Robotframework
| PASS |
2 tests, 2 passed, 0 failed
=================================================================
=============
```

| | |
|---|---|
| Output: | /home/vagrant/robotframework_output_2022May31_222440.xml |
| Log: | /home/vagrant/robotframework_log_2022May31_222440.html |

Report:
/home/vagrant/robotframework_report_2022May31_222440.html
+----------------------------------------------------------------
--------------+
| Robotframework Report - Robot 5.0.1 - Python 3.6.9 on Linux
|
| -----------------------------------------------------------
| Total Test Cases: 1 / Passed: 1 / Failed: 0
|
+----------------------------------------------------------------
--------------+
- Test case: Robotframework.Test Robotframework Tc1 (Total: 2 /
Passed: 2 / Failed: 0 / Skipped: 0)
(virtual_python) vagrant@demo-machine:~$
(virtual_python) vagrant@demo-machine:~$
(virtual_python) vagrant@demo-machine:~$
(virtual_python) vagrant@demo-machine:~$

### Update Process

The update process is part of SCM (i.e., source control management) and it should be provided through third party integration or user dedicated SCM. There are three main data that need to be maintained: users' test procedure, describing snippet, generated templates. The generated test scripts are optional.

Users' test procedure:

```
  Device: using unreal-device with host address 1.1.1.1
  Test Procedure:
    Precondition: using “show version” command to verify that
    its software version must be newer than 1.0.0
    Verification 1:
using “show modules” command line to verify that there are 4 running
modules
using “show modules csv-format” command line to verify that there are
4 running modules
using “show modules json-format” command line to verify that
there are 4 running modules
```

Describing Snippet:

```
(virtual_python) vagrant@demo-machine:~$
(virtual_python) vagrant@demo-machine:~$
(virtual_python) vagrant@demo-machine:~$ cat
describing_snippet_files/snippet_testcase1.txt
setup
  connect device 1.1.1.1
section: precondition
  1.1.1.1 execute show version using-template
unrealos.show_version select version where version >=
version(1.0.0) must be True
section: verify that there are 4 running modules
  1.1.1.1 execute show modules using-template
unrealos.show_modules select * where status == Running MUST BE
EQUAL_TO 4
  1.1.1.1 execute show modules csv-format using-csv select *
where status == Running MUST BE EQUAL_TO 4
  1.1.1.1 execute show modules json-format using-json select *
where status == Running MUST BE EQUAL_TO 4
teardown
  release device 1.1.1.1
(virtual_python) vagrant@demo-machine:~$
(virtual_python) vagrant@demo-machine:~$
```

Generated TextFSM templates:

(virtual_python) vagrant@demo-machine:~$
(virtual_python) vagrant@demo-machine:~$
(virtual_python) vagrant@demo-machine:~$ dgs search template
“unrealos*”
+----------------------------------------------------------------
--------------+
| Found 2 template ID (s) matching “unrealos*” pattern:
|
| - unrealos.show_modules
|
| - unrealos.show_version
|
+----------------------------------------------------------------
--------------+
+----------------------------------------------------------------
--------------+
| Template ID: unrealos.show_modules
|
+----------------------------------------------------------------
--------------+
#################################################################
###############
# Template is generated by templateapp Community Edition

| # Created by | : user1 |
|---|---|
| # Email | : user1@abc xyz.com |
| # Company | : ABC XYZ Inc. |
| # Created date | : 2022-05-27 |

#################################################################
###############
Value module (\d+)
Value name ([a-zA-Z0-9]+( [a-zA-Z0-9]+)*)
Value model (\S*[a-zA-Z0-9]\S*)
Value version ([0-9]\S*)
Value status ([a-zA-Z0-9]+)
Start
\hat{ }${module} +${name} +${model} +${version} +${status} *$$ −>
Record
+----------------------------------------------------------------
--------------+
| Template ID: unrealos.show_version
|
+----------------------------------------------------------------
--------------+
#################################################################
###############
# Template is generated by templateapp Community Edition

| | |
|---|---|
| # Created by | : user1 |
| # Email | : user1@abc xyz.com |
| # Company | : ABC XYZ Inc. |
| # Created date | : 2022-05-31 |

#################################################################
###############
Value version ([0-9]\S*)
Start
\hat{ }\S*[a-zA-Z0-9]\S*( \S*[a-z-Z0-9]\S*)*, Unreal-Device-OS,
Version $ {version} *$$
(virtual_python) vagrant@demo-machine:~$
(virtual_python) vagrant@demo-machine:~$
(virtual_python) vagrant@demo-machine:~$

### Approve Process

Users might consider the approval of describing snippet after reviewing the test result on single device under test. If users want more test result by executing multiple devices on same snippet, the syntax is {host_address_1, host_address_2, . . . , host_address_n}:

### Deploy Process

In some embodiments, this invention does not require one to reinvent collaboration, a bug tracking system, continuous integration and continuous delivery, source code management, or reporting tools for deploying processes. In these embodiments, it would integrate with third party vendor(s) or other sources to provide the best solution for users. In other embodiments, features comprising collaboration, bug tracking, continuous integration and continuous delivery, source code management, and/or reporting tools for deploying processes are provided by the for the productivity test tool of this invention.

### The Productivity Test Script Development Process And Timeline

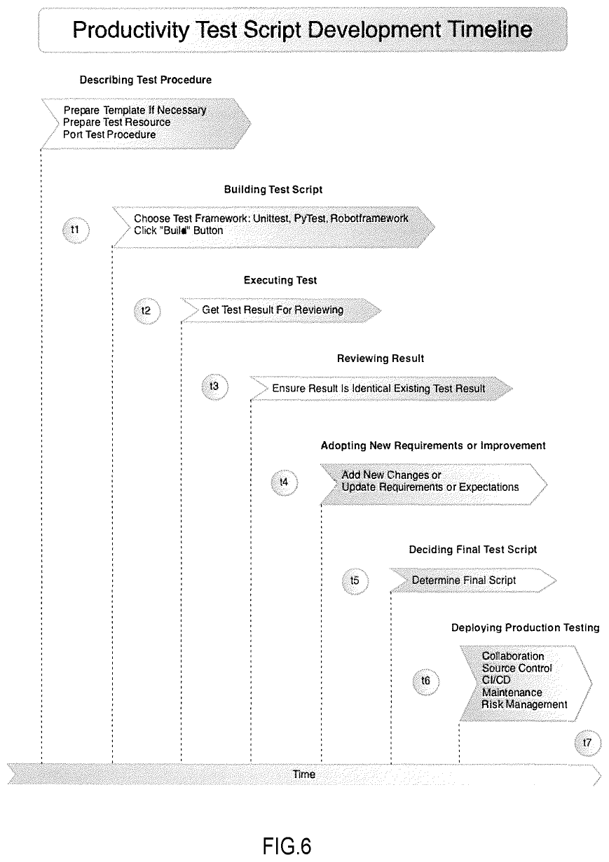

In preferred embodiments of this invention, the processes of productivity test script development are “describe”, “build”, “execute”, “review”, “adopt/update”, “decide”, and “deploy”. FIG. 3 provides an illustration of certain of these embodiments, including describe 320, build 332, execute 400, review 340, adopt/update 370/331, decide 350, and deploy 420. FIG. 6 also provides an illustration of certain of these embodiments, shown in an exemplary order with respect to time, including describing, building, executing, reviewing, adopting deciding and deploying, with respect to steps 11 through 17 shown in the figure.

The “describe” process requires three tasks: preparing template(s), preparing test resource, and porting test procedure to Productivity Test Automation System language. If templates are available, preparing template tasks need to be skipped.

The “build” process requires tester to choose a desire test framework and click “Build” button.

The “execute” and “review” processes are similar to other test automation processes. Productivity Test Automation System cannot help these processes.

The “adopt/update” process is needed when tester wants to update new requirements or tester finds some missing test result during describing test procedure and it needs an improvement to clarify the result. This process happens in an iteration of “adopt >update >build >execute >review”. This process is called “adopt” process because the changes or modifications are made by tester.

The “decide” process determines the final test script for production testing. If the final test script is confirmed by a tester, this process is named as the “decide” process. However, when the final test script needs other sign-off or other review, then this process becomes “approve” process.

The “deploy” process is similar to other test automaton processes.

The relevant time for these processes can be analyzed as follows. T1 is the amount of time to describe the test procedure; T1_1 is the total time to prepare template; T1_2 is a total time to prepare resources; and T1_3 is a total time to port test procedure. T1_1 is often fluctuating because it depends on the template availability. Sometimes, T1_1 is zero because all templates are available for that particular test case. T1_2 and T1_3 might be considered as fluctuating only a small amount in some cases because these tasks can be reused from another test.

T2 is the amount of time to build test script. T2 is often fixed work because it only requires the tester to choose test framework and click “build” button.

T3 is the amount of time to execute the test. T3 is similar to other test automation.

T4 is the amount of time to review a test result. T4 might be efficient because the tester quickly recognizes test results from his or her layout workflow of test.

T5 is the total time to adopt new requirements or improvement. T5 often determines as a total time of n iteration*(T1+T2+T3+T4) where n iteration is at least 1.

T6 is the amount of time to decide the final test script. If the tester is the only person to decide the final test script, T6 can be considered as zero. If the final test script requires sign-off or other code reviewers, T6 depends on sign-off or code reviewing process.

T7 is an amount of time to perform continuous integration and continuous delivery, maintenance, and risk management. T7 is efficient when using the right tool, organizing and clarifying process to prevent blockers.

### Applications Of Embodiments Of The Invention To Solve Problems

### Problem 1: High Cost Of Implementation

The embodiments of the Productivity Test Automation System of this invention may be used to solve the high cost of test automation implementation. This solution applies the most value-added processes and reduces non-value-added processes as much as possible to approach the most agile test automation development.

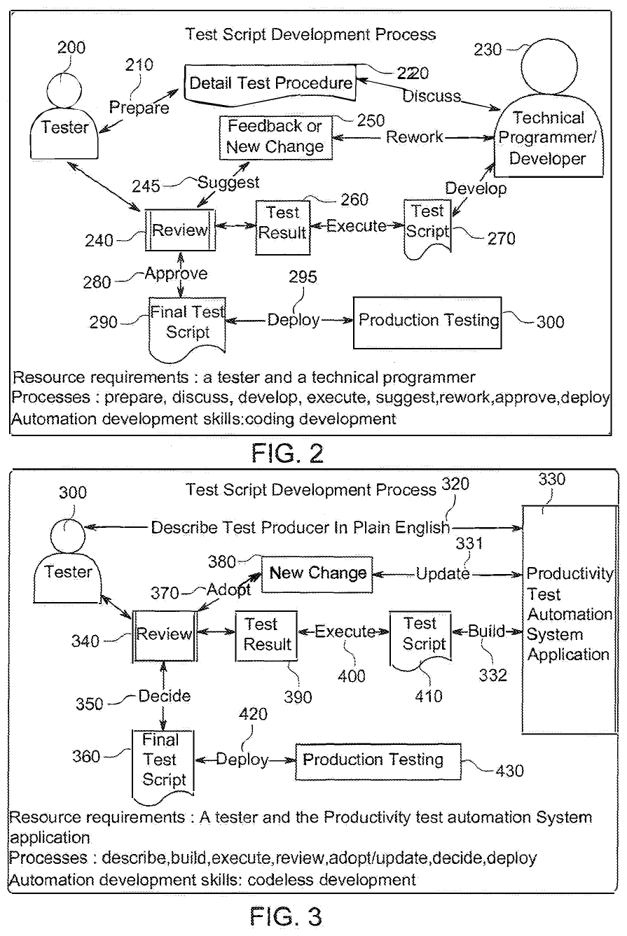

Process: The traditional test automation (e.g., FIG. 2) often uses a “prepare-discuss-develop-execute-review-suggest-rework-approve-deploy” process for test automation development that might cause miscommunication, garner insufficient support, duplicate work, and overestimate delivery problems because it needs tester and developer to work together. With embodiments of the Productivity Test Automation System of this invention (e.g., FIG. 3), the process simplifies to “describe-build-execute-review-adopt-update-decide-deploy” that lets the testers describe the test procedure to build test script.

Communication: Communication can need to occur when a developer needs to understand the test procedure and when developer needs to rework the test script per the tester's suggestion. Misunderstanding or misinterpreting the requirements or expectations might be a problem of some reworks. This problem can be solved or reduced by embodiments of the Productivity Test Automation System of this invention because a tester directly describes a test case to the system in plain English.

Support: Support can be needed when a developer develops a test script that needs to consider other forms of test data to produce a correct algorithm. The request for support will depend on tester availability and time zone, for example. Sometimes, developers might wait for several days to get an answer. This problem should be solved or reduced by embodiments of the Productivity Test Automation System of this invention because a tester is also a developer.

Verification method: Developers have different technical work experience and programming skills to produce test script. More often, developers will create their own verification method and verification unit test. Sometime, the verification algorithms overlap or duplicate. Furthermore, code might break or produce unexpected results if algorithm verification does not perform full unit test thoroughly. This will be solved or reduced by embodiment of the Productivity Test Automation System of this invention because they use the single verification method to parse and verify test data.

Estimation: Sometimes, developers overstate or underestimate the completion of test script that might cause interruption, unnecessary work, or delay of test automation project delivery. With embodiments of the Productivity Test Automation System invention, project manager or tester can project the test script completion by planning “amount of work and time to describe test”+“amount of work and time to build test script”+“amount of work and time to execute test”+“amount of work and time to review result”+“amount of work and time to adopt new change(s).”

In summary, embodiments of the Productivity Test Automation System of this invention can improve the cost of test automation implementation by leveraging “describe-build-execute-review-adopt-update-decide-deploy” processes with the subtraction of miscommunication, excessive or insufficient support, overlap or duplicate work, and overstating or underestimating deliveries.

### Problem 2: Lack Of Skilled Automation Resources

The embodiments of the Productivity Test Automation System of this invention may be used to solve or reduce problems in hiring skilled automation resources by engaging existing workforce to apply test automation or by reducing the complexity of test automation development job requirements and qualification.

Assuming an exemplary test team has 20 projects that need to transform to digital test automation, with a test automation strategy that requires technical automation developers plus support from testers, a project manager could reasonably project that one developer will complete developing test automation for one project in 6 months. To increase the speed of test automation, the project manager needs 20 developers plus support from multiple testers to complete their workload in 6 months. Unfortunately, hiring managers can often not bring this many developers and testers on board. As a result, to complete test automation for 20 projects often requires 24 months.

With embodiments of the Productivity Test Automation System of this invention, the existing workforce can be engaged to improve and/or automate development. Testers from the current team can become developers to build test script. If more resources are needed to accelerate test automation, hiring managers can borrow other testers within the company or bring new testers on board. The total amount of work and time to complete the test automation will depend on planning and providing strategy to optimize the embodiments of the Productivity Test Automation System and the associated timelines: “amount of work and time to describe test”+“amount of work and time to build test script”+“amount of work and time to execute test”+“amount of work and time to review result”+“amount of work and time to adopt new changes” +“amount of work and time to perform continuous integration and continuous delivery, maintenance, and risk management”.

With embodiments of the Productivity Test Automation System of this invention, there may be a reduction in the test automation development job requirements and qualifications needed when the Productivity Test Automation System uses the Describe-Get-System to produce work. All prepared documents for the system are very self-explanatory so that most inexperienced workers with high school diplomas can perform the work. To avoid any risk during development, execution, maintenance, and reporting, managers might consider a backup plan for hiring one technical programmer to supervise test scripts and one experienced tester to act as interpreter for porting test procedure and helping test result (Note: all technical support for source control, continuous integration and continuous delivery, bug tracking, and reporting services should fully provide through third-party integration contract agreement). As a result, the total workforce to help test automation development for 20 projects might be 20 workers with various work experience and qualifications plus one experienced tester and one technical programmer if the business requires such. This solution could quickly solve shortages in the skilled test automation workforce.

In conclusion, depending on business requirements and compliance, tester or manager might consider the best solution to achieve productivity and quality test automation development without any blockage or shortage in the test automation workforce.

### Problem 3: Quality

The embodiments of the Productivity Test Automation System of this invention may be used to solve or reduce problems in the quality of test automation development because they apply the Describe-Get-System. In other words, they use the “What You Describe Is What You Get” principle to improve the quality for test automation development. Furthermore, embodiments of the Productivity Test Automation System of this invention explore generic requirements, specific requirements, implicit expectations, and explicit expectations to strengthen the result of testing.

### Problem 4: High Cost Of Maintenance

The embodiments of the Productivity Test Automation System of this invention may be used to solve or reduce problems with the high cost of maintenance because it uses codeless development to let users autogenerate the test script. Any modification or improvement of existing test script only needs to describe new requirements or expectations. As a result, a new tester or co-worker can carry on other tester work.

### Particular Applications To Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A productivity test tool for use by a tester, the productivity test tool comprising:
(a) a memory device;
(b) a processing device coupled with the memory device, the processing device comprising multiple capabilities, the multiple capabilities comprising the capability to: (i) receive a test procedure in plain English from the tester; (ii) build a proposed test script; (iii) execute the proposed test script to obtain a test result; (iv) review the test result; (v) adopt a change to the test script after the review of the test result, (vi) update the proposed test script, and repeat (ii) through (iv); (vii) decide to accept a final test script; and (viii) deploy the final test script to production testing;
(c) an integrated collaboration tool coupled with the processing device;
(d) a continuous integration and continuous delivery tool coupled with the processing device;
(e) a bug tracking tool coupled with the processing device; and
(f) a report tool coupled with the processing device.

2. The productivity test tool of claim 1 wherein the productivity test tool operates without the tester directly writing software code.

3. A method of testing software by a tester, the method comprising:
(a) describing a software test procedure in plain English and transferring the test procedure description to a productivity test tool;
(b) building a test script from the test procedure description in the productivity test tool;
(c) executing the test script to obtain a test result;
(d) reviewing the test result;
(e) adopting a change to the test script after reviewing the test result;
(f) updating the test script in the productivity test tool, and repeating (c) and (d);
(g) deciding to accept a final test script or repeating (e) and (f);
(h) deploying the final test script in production testing; and
(i) integrating with a collaboration tool, a continuous integration and continuous delivery tool, a bug tracking tool, and a report tool.

4. The method of claim 3, wherein the method is practiced by the tester without the tester directly writing software code.

5. A describe-get-tool for use by a tester with a productivity test tool for which the tester provides test requirement inputs, the describe-get-tool comprising:
(a) an interpreter tool that interprets the test requirement inputs to provide a workflow;
(b) a generator tool that processes the workflow to produce test scripts for test execution;
(c) a contractor tool that lets the tester choose at least one other user to use the describe-get-tool; and
(d) a report tool that provides an analysis report regarding test execution.

5. The describe-get-tool of claim 4 wherein the describe-get-tool applies What You Describe Is What You Get.

6. A productivity test tool for testing a device corresponding to testing requirements, the productivity test tool comprising:
(a) a connector tool, the connector tool interacting with the device that is being tested;
(b) a describe-get-tool, the describe-get-tool interpreting the testing requirements to generate a test script; and
(c) an integration tool, the integration tool improving the quality and productivity of the testing by applying a collaboration tool, a continuous integration and continuous deliver tool, a bug tracking tool, and a report tool.

7. The productivity test tool of claim 6, wherein the device that is being tested is test equipment for use in data processing.
